(19) United States
(12) Patent Application Publication
(10) Pub. No.: US 2009/0089866 A1
(43) Pub. Date: Apr. 2, 2009

(54) ACCESS AUTHORIZATION SYSTEM, ACCESS CONTROL SERVER, AND BUSINESS PROCESS EXECUTION SYSTEM

(76) Inventors: Akifumi Yato, Kawasaki (JP); Tadashi Kaji, Yokohama (JP); Dan Yamamoto, Yokohama (JP); Shinichi Irube, Yokohama (JP); Naoki Hayashi, Yokohama (JP)

Correspondence Address: MCDERMOTT WILL & EMERY LLP, 600 13TH STREET, N.W., WASHINGTON, DC, 20005-3096, US

(21) Appl. No.: 12/239,058

(22) Filed: Sep. 26, 2008

(30) Foreign Application Priority Data
Sep. 27, 2007 (JP) 2007-252358
Sep. 3, 2008 (JP) 2008-225961

(51) Int. Cl. H04L 9/32; G06F 7/04; G06F 17/30

(52) U.S. Cl. 726/6; 726/2; 726/3

(57) ABSTRACT

An access authorization system is provided, which can reduce the user wait time until the provision of a user-requested service. The access authorization system of the present invention specifies the next service to be provided to a UT (a client-side communication device) after the service currently being provided to the UT, and then executes process to make an authorization decision in advance regarding the next service with respect to the user of the UT, before the UT requests the next service.

### INCORPORATION BY REFERENCE

This application claims priority based on Japanese patent applications, No. 2007-252358 filed on Sep. 27, 2008 and No. 2008-225961 filed on Sep. 3, 2008, the entire contents of which are incorporated herein by reference.

### BACKGROUND OF THE INVENTION

The present invention relates to technology that makes an authorization decision for determining, on the basis of a service request from a client-side communication device, whether or not the provision of the requested service is permitted for the user using the communication device.

In the current environment of the Internet, it is becoming possible to use a variety of services, including electronic commerce services. Among such services, there are services that require the input of personal information such as the user's name and address, as well as services that cause money to be sent and received. For managing these services safely, there is a need for user identification to prevent spoofing, as well as a mechanism for ensuring security about protection of privacy. More particularly, security measures such as user authentication, judgment for each user to determine whether or not a service is available for use (i.e., authorization), per-user access control, and data encryption are very important for achieving safe communications.

However, as the number of services provided to users is increased, the costs and expenses for security measures required for both providers and users are also swollen. For example, user authentication is normally indispensable for membership services such as net shopping sites or online banking. If user attempts to use a plurality of services in which user authentication is required, then, every time to use the services, the user has to input authentication information such as an ID, password, or a digital certificate.

Users might be bothered, not only by above described operations, but also by chore for self-managing such a plurality of authentication information. Meanwhile, the service provider must prepare an independent authentication server or an application server provided with authentication functions, and thus installation and operational costs for such servers are also enlarged.

Consequently, in recent years there has been a rising need for SSO (Single Sign-On), in which the user is able to use a plurality of services by a single user authentication. SSO is a system where, once an authentication of a user is approved, the user is allowed to use the plurality of services without signing on to each service individually. Typically, the authentication used for SSO is managed by a third party independent from the user and the service provider.

For example, in “Security Assertion Markup Language (SAML) v2.0,” OASIS Security Services TC (2005), http://docs.oasis-open.org/security/saml/v2.0/saml-2.0-os.zip (hereinafter, referred to as Non-Patent Document 1), technical specifications of SAML (Security Assertion Markup Language), to realize SSO, are defined. Once an authentication of user is approved by a third party SAML authority, the SAML authority transmits an authentication assertion (i.e., the user authentication result) to the service provider, thereby reducing number of times to input the authentication information for using each service.

In addition, the SAML authority in the Non-Patent Document 1 not only conducts a user authentication instead of users or providers, but also checks the user's service utilization right and conducts authorization of the service use instead of users and providers. The SAML authority manages attribute information, such as the user's affiliations, address, and credentials, as well as policy information for authorizing the use of a service. When the user requests a service, the SAML authority determines whether to permit or deny use of the requested service on the basis of the attribute information and the policy information, and then issues an authorization assertion as the result of determination. The service provider receives the authorization assertion from the SAML authority, and then conducts control of access of the user in accordance with the received authorization assertion. Thus, it could be understood that a merit using the SAML is that it could eliminate the need for each service provider to prepare individual servers for making authorization decisions.

Furthermore, in the Web services of the related art, it has been typical for service providers to build in all elements constituting a service in advance. However, in recent years an interoperable services approach is increasingly favored, wherein the elements constituting a service are combined according to particular circumstances to thereby realize a single business process.

As one example of existing technology for realizing service interoperability, there is known BPEL (Business Process Execution Language for Web Services), which is a technique for linking individual Web services as elements constituting a larger service (for example OASIS Standard, “Web Services Business Process Execution Language Version 2.0”, OASIS Web Services Business Process Execution Language (WSBPEL) TC (2007), http://docs.oasis-open.org/wsbpel/2.0/OS/wsbpel-v2.0-OS.pdf, hereinafter referred to as Non-Patent Document 2). BPEL is a language for specifying the execution sequence of a plurality of Web services as a process flow for a series of business processes. The functional unit that interprets and executes business processes stated in BPEL is called BPEL engine.

### SUMMARY OF THE INVENTION

The SAML authority explained in the above Non-Patent Document 1 conducts an authorization at each time when the user accesses a service. Thus, if the user requests the service, unless the authorization decision is completed, the service could not be provided to the user. In other words, the user must wait for the provision of the service until the authorization decision is completed. The process load required for conducting individual authorization decision is not so heavy. Therefore, if the number of users requesting a service is small, the authorization decision might be completed in short period of time. Thereby user's time to wait for the service is short.

The SAML authority explained in the Non-Patent Document 1 conducts all authorization decisions in an integrated manner. Thus, if a large number of users request the provision of services during a short period of time, the process load on the SAML authority might increase and thereby prolongs time required for individual authorization decisions. If the time for authorization decisions increases, it prolongs user's time to wait for the service and thereby worsens a usability.

In addition, in using BPEL as described in Non-Patent document 2, if authorization decisions are to be made regarding respective services in a series of business processes after those services are to be called, then the user wait time until provision of the respective services commences may increase.

In view of above described, the present invention is focused on an object to reduce the user's time to wait for provision of a user-requested service.

In order to solve the above problem, the present invention provides an access authorization system that specifies a service to be provided to a client-side communication device following after the service currently being provided to the communication device, and then, before the communication device requests a next service, executes authorization decision process for the next service for the user of the communication device, in advance.

For example, a first aspect of the present invention is relating to an access authorization system that makes an authorization decision for determining, on the basis of a service request from a client-side communication device, whether or not the provision of the requested service is permitted for the user using the communication device.

The access authorization system is provided with a policy management server, an authorization server, and an access control server.

The policy management server includes:

user attribute information storage unit for storing user attribute information for each user ID identifying a user of the client-side communication device;

service policy information storage unit for storing service policy information for each service ID identifying a service, the service policy information indicating conditions of a user to be permitted to receive a provided service; and

information management unit that, upon receiving a registration information query request containing a user ID and a service ID from the access control server, extracts user attribute information corresponding to the user ID from the user attribute information storage unit, extracts service policy information corresponding to the service ID from the service policy information storage unit, and then transmits to the access control server a registration information query response containing the extracted user attribute information and service policy information.

The authorization server includes:

authorization decision unit that, upon receiving from the access control server an authorization decision request containing user attribute information and service policy information, determines whether or not the user attribute information satisfies the service policy information, and then transmits the authorization decision response containing authorization decision result, the user ID subject to the authorization decision result, and the service ID subject to the authorization decision result to the access control server.

The access control server includes:

next service ID storage unit for storing, for each service ID, the service ID for the next service to be provided;

authorization decision requesting unit that, upon receiving an authorization information query request requesting the acquisition of authorization information indicating whether or not the user of the client-side communication device is permitted to use a service and containing the user ID the user and the service ID of the service, transmits to the policy management server a registration information query request containing the user ID and the service ID, and upon receiving from the policy management server a registration information query response containing the user attribute information corresponding to the user ID and the service policy information corresponding to the service ID, transmits to the authorization server an authorization decision request containing the user attribute information and the service policy information, and upon receiving from the authorization server an authorization decision response, outputs an authorization information query response containing the authorization decision result, the user ID, and the service ID that were contained in the authorization decision response; and

next service specifying unit that, after the authorization decision requesting unit outputs the authorization information query response, refers to the next service ID storage unit on the basis of the service ID of the service subject to the authorization decision result contained in the authorization information query response, extracts the service ID of the next service to be provided, and then transmits the extracted service ID along with the user ID of the user subject to the authorization decision result to the authorization decision requesting unit.

During the period between outputting the authorization information query response and receiving another authorization information query request containing a user ID identical to the user ID contained in the authorization information query response, the authorization decision requesting unit acquires from the policy management server the user attribute information and the service policy information corresponding to the user ID and the service ID received from the next service specifying unit, and then transmits to the authorization server an authorization decision request containing the user attribute information and the service policy information. In so doing, an access authorization system is provided wherein the authorization server is made to execute authorization decision process in advance regarding the combination of the user corresponding to the user ID and the service corresponding to the service ID.

As another example, a second aspect of the present invention is an access control server used in an access authorization system that, on the basis of a service request from a client-side communication device, makes an authorization decision for determining whether or not the provision of the requested service is permitted for the user using the communication device.

The access authorization system is provided with a policy management server that includes

user attribute information storage unit for storing user attribute information for each user ID identifying a user of the client-side communication device,

service policy information storage unit for storing service policy information for each service ID identifying a service, the service policy information indicating conditions of a user to be permitted to receive a provided service, and

information management unit that, upon receiving a registration information query request containing a user ID and a service ID, extracts user attribute information corresponding to the user ID from the user attribute information storage unit, extracts service policy information corresponding to the service ID from the service policy information storage unit, and then returns a registration information query response containing the extracted user attribute information and service policy information.

The access authorization system is also provided with an authorization server that includes

authorization decision unit that, upon receiving an authorization decision request containing user attribute information and service policy information, makes an authorization decision determining whether or not the user attribute information satisfies the service policy information, and then returns the authorization decision result as an authorization decision response containing the user ID and the service ID subject to the authorization decision result.

The access authorization system is also provided with an access control server that includes:

next service ID storage unit for storing, for each service ID, the service ID for the next service to be provided after the service corresponding to the first service ID;

authorization decision requesting unit that, upon receiving an authorization information query request requesting the acquisition of authorization information indicating whether or not the user of the client-side communication device is permitted to use a service and containing the user ID of the user and the service ID of the service, transmits to the policy management server a registration information query request containing the user ID and the service ID, and upon receiving from the policy management server a registration information query response containing the user attribute information corresponding to the user ID and the service policy information corresponding to the service ID, transmits to the authorization server an authorization decision request containing the user attribute information and the service policy information, and upon receiving from the authorization server an authorization decision response, outputs an authorization information query response containing the authorization decision result, the user ID, and the service ID that were contained in the authorization decision response; and

next service specifying unit that, after the authorization decision requesting unit outputs the authorization information query response, refers to the next service ID storage unit on the basis of the service ID of the service subject to the authorization decision results contained in the authorization information query response, extracts the service ID of the next service to be provided, and then transmits the extracted service ID along with the user ID of the user subject to the authorization decision result to the authorization decision requesting unit.

During the period between outputting the authorization information query response and receiving another authorization information query request containing a user ID identical to the user ID contained in the authorization information query response, the authorization decision requesting unit acquires from the policy management server the user attribute information and the service policy information corresponding to the user ID and the service ID received from the next service specifying unit, and then transmits to the authorization server an authorization decision request containing the user attribute information and the service policy information. In so doing, an access authorization server is provided wherein the authorization server is made to execute authorization decision process in advance regarding the combination of the user corresponding to the user ID and the service corresponding to the service ID.

As another example, a third aspect of the present invention is a business process execution system that makes an authorization decision for determining, with respect to a business process made up of a plurality of services requested by a client-side communication device, whether or not the provision of individual services included in the business process is permitted for the user of the communication device.

The business process execution system is provided with a user attribute management server, a policy management server, an authorization server, and a service execution server.

The user attribute management server includes:

user attribute information storage unit for storing user attribute information for each user ID identifying a user of the client-side communication device; and

user attribute information management unit that, upon receiving a user attribute query request containing a user ID from the authorization server, extracts user attribute information corresponding to the user ID from the user attribute information storage unit, and then transmits to the authorization server a user attribute query response containing the extracted user attribute information.

The policy management server includes:

service policy information storage unit for storing service policy information for each service ID identifying a service, the service policy information indicating conditions of a user to be permitted to receive a provided service; and

policy information management unit that, upon receiving a policy query request containing a service ID from the authorization server, extracts service policy information corresponding to the service ID from the service policy information storage unit, and then transmits to the authorization server a policy query response containing the extracted service policy information.

The authorization server includes:

authorization decision unit that, upon receiving from the service execution server an authorization decision request containing a user ID and at least one service ID, transmits to the user attribute management server a user attribute query request containing the user ID, acquires user attribute information corresponding to the user ID, transmits to the policy management server a policy query request containing the service ID, acquires service policy information corresponding to the service ID, subsequently determines whether or not the acquired user attribute information satisfies the acquired service policy information, and then transmits to the service execution server an authorization decision response containing an authorization decision result for each service ID.

The service execution server includes:

scenario storage unit for storing service scenarios that stipulate the provision order for a plurality of services included in a business process, the service scenarios being respectively stored in association with a scenario ID that identifies a particular service scenario; and

scenario execution unit that, upon receiving a service request containing a user ID and a scenario ID from a client-side communication device, acquires the service scenario corresponding to the scenario ID from the scenario storage unit, and then transmits to the authorization server an authorization decision request containing the user ID as well as the service IDs of the respective services contained in the acquired service scenario, thereby acquiring an authorization decision result for respective services contained in the service scenario. If the entire series of services included in the service scenario are permitted, then the scenario execution unit issues a request of provision of the service for the user of the user ID to the service-providing server that executes the first service to be provided in the service scenario.

According to the present invention, the user wait time until the provision of a user-requested service commences can be reduced.

These and other benefits are described throughout the present specification. A further understanding of the nature and advantages of the invention may be realized by reference to the remaining portions of the specification and the attached drawings.

### BRIEF DESCRIPTION OF THE DRAWINGS

FIG. 1 is a system configuration diagram showing an exemplary configuration of an access authorization system in accordance with the first embodiment.

FIG. 2 is a diagram showing an exemplary configuration of the data stored in the communication management table storage unit.

FIG. 3 is a diagram showing an exemplary configuration of the data stored in the communication management table storage unit.

FIG. 4A to 4F are diagrams showing exemplary configurations of communication start request, communication start response, authorization information query request, authorization information query response, registration information query request, and registration information query response respectively.

FIG. 5A to 5E are diagrams showing exemplary configurations of user attribute information, service policy information, authorization decision request, authorization decision response, and authorization information respectively.

FIG. 6A to 6F are diagrams showing exemplary configurations of registration information update request, registration information update response, authorization information deletion request, and authorization information deletion response respectively.

FIG. 7 is a diagram showing an exemplary configuration of the data stored in the access history storage unit.

FIG. 8 is a diagram showing an exemplary configuration of the data stored in the authorization information storage unit in accordance with the first embodiment.

FIG. 9 is a diagram showing an exemplary configuration of the data stored in the next service ID storage unit.

FIG. 10 is a diagram showing an exemplary configuration of the data stored in the service policy information storage unit.

FIG. 11 is a diagram showing an exemplary configuration of the data stored in the user attribute information storage unit.

FIG. 12 is a sequence diagram showing an example of process to initiate provision of a service, as conducted by the access authorization system in accordance with the first embodiment.

FIG. 13A to 13C are diagrams showing, by way of example, the contents of the authorization information storage unit in the first embodiment before initiating service provision, after initiating service provision, and after having made an authorization decision in advance respectively.

FIG. 14 is a sequence diagram showing an example of process to update registration information, as conducted by the access authorization system in accordance with the first embodiment.

FIG. 15 is a system configuration diagram showing an exemplary configuration of an access authorization system in accordance with the second embodiment.

FIGS. 16A and 16B are diagrams showing exemplary configurations of authorization information transmission notification and notification of authorization information transmission completion respectively.

FIG. 17 is a diagram showing an exemplary configuration of the data stored in the authorization information storage unit in accordance with the second embodiment.

FIG. 18 is a diagram showing an exemplary configuration of the data stored in the service history storage unit.

FIG. 19 is a sequence diagram showing an example of process to initiate provision of a service, as conducted by an access authorization system in accordance with the second embodiment.

FIG. 20 is a sequence diagram showing an example of process to update registration information, as conducted by an access authorization system in accordance with the second embodiment.

FIG. 21 is a system configuration diagram illustrating an exemplary configuration of a business process execution system in accordance with a third embodiment.

FIG. 22 is a diagram showing an exemplary configuration of the data stored in the scenario storage unit.

FIG. 23 is a diagram showing an exemplary configuration of the data of service scenario.

FIG. 24 is a diagram showing an exemplary configuration of the data stored in the process information storage unit.

FIGS. 25A and 25B are diagrams showing exemplary configurations of authorization decision request and authorization decision result respectively.

FIG. 26 is a flowchart showing, by way of example, prohibited service registration process executed by the scenario execution unit.

FIG. 27 is a flowchart showing, by way of example, prohibition decision process (S600).

FIG. 28A to 28D are diagrams showing exemplary configurations of user attribute query request, user attribute query response, policy query request, and policy query response respectively.

FIG. 29 is a diagram showing an exemplary configuration of the data stored in the scenario policy information storage unit.

FIG. 30 is a sequence diagram showing, by way of example, the operation of a business process execution system in accordance with the third embodiment.

FIG. 31 is a sequence diagram showing, by way of example, authorization decision process (S800) in accordance with the third embodiment.

FIG. 32 is a hardware configuration diagram showing an exemplary configuration of a computer for realizing the functions of the ACS, the PMS, the CMS, the AuS, the UT, the SP, the SES, or the AS.

FIG. 33 is a sequence diagram showing, by way of another example, the operation of a business process execution system in accordance with the third embodiment.

### DETAILED DESCRIPTION OF THE EMBODIMENTS

Hereinafter, exemplary embodiments of the present invention will be described in detail with reference to the accompanying drawings.

In the following exemplary embodiments 1 and 2, an access authorization system 10 that uses SIP (Session Initiation Protocol) will be described by way of example.

SIP is a communication protocol for managing and controlling communication sessions, and is defined by the IETF in RFC 3261. In addition, among the system configuration elements that appear in each exemplary embodiment, identical elements that appear in a plurality of locations are represented as SP (service providing server)-α, SP-β, and so on. Furthermore, when collectively describing a plurality of elements, such as when collectively describing SP-α and SP-β as a service providing server, the plurality of elements will be simply referred to as SP, for example.

In addition, in each of the following exemplary embodiments, a user refers to a person who operates a user terminal (UT) 500. A service refers to the features of an application that is operated upon an SP 600 and used by a user via a UT 500. Attribute information is information described in a computer-interpretable format, and includes information such as the user's sex, name, or age, or alternatively, information such as the service category (such as video delivery or product transaction), charge, or quality.

Service policy information is information described in a computer-interpretable format that defines the criteria for using a service. For example, the service policy information may be rules indicating that only users aged 20 years or older, only users living in a specified region, or only users who have paid a fee equal to or greater than a fixed amount are able to use a service. Authentication information is information whereby the SP 600 performs access control with respect to a user, and is created by the access control server (ACS) 100 on the basis of the decision results of the authorization server (AuS) 400. Control communication refers to communication conducted between the UT 500 and the communication management server (CMS) 300, as well as between the SP 600 and the CMS 300, and is for example communication used in SIP. Data communication refers to communication conducted between the UT 500 and the SP 600 without passing through the CMS 300.

### Embodiment 1

A first embodiment of the present invention will now be described.

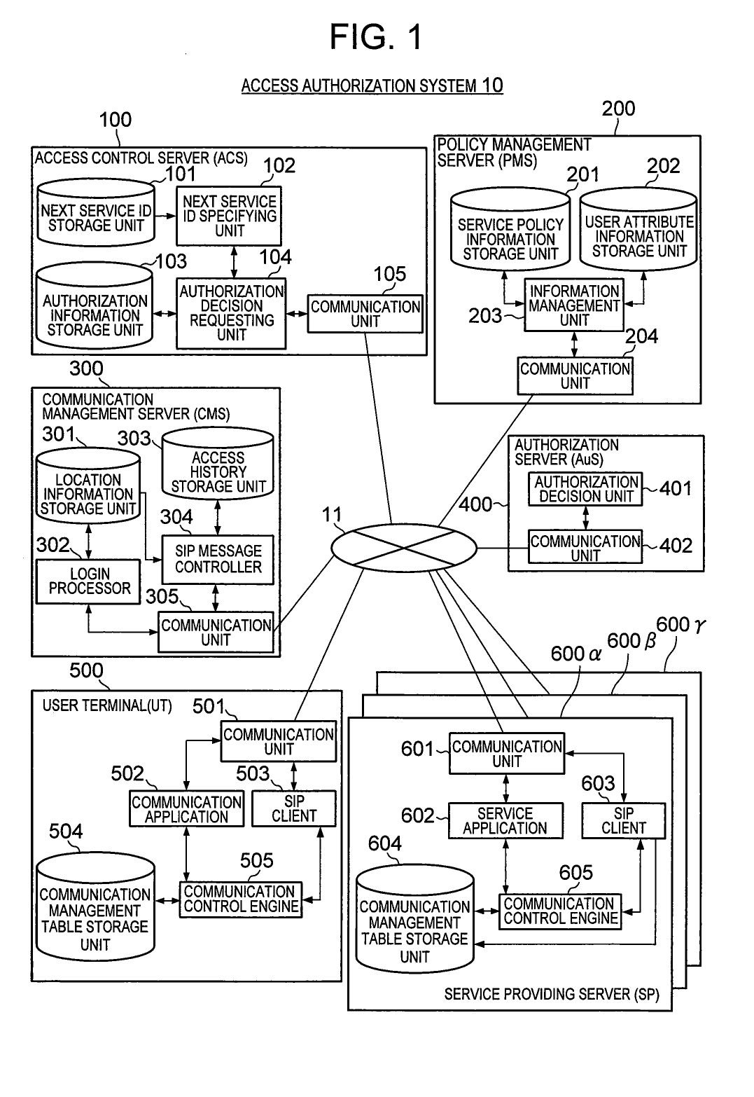

FIG. 1 is a system configuration diagram illustrating an exemplary configuration of an access authorization system 10 in accordance with the first embodiment. The access authorization system 10 is provided with an access control server (ACS) 100, a policy management server (SMS) 200, a communication management server (CMS) 300, an authorization server (AuS) 400, a user terminal (UT) 500, and a plurality of service providing servers (SP) 600. The ACS 100, the PMS 200, the CMS 300, the AuS 400, the UT 500, and the SP 600 mutually communicate via a network 11.

When a user tries to use a service via the UT 500 in the access authorization system 10 shown in FIG. 1, the ACS 100 (a third party) makes a service authorization decision with respect to the user in conjunction with the PMS 200 and the AuS 400. The CMS 300 then conducts access control on the basis of the result of the authorization decision.

The functions provided in each of the configuration elements of the access authorization system 10 in accordance with the present embodiment will now be described.

First, the UT 500 will be described. The UT 500 is provided with a communication unit 501, a communication application 502, a SIP client 503, a communication management table storage unit 504, and a communication control engine 505. It should be appreciated that while the UT 500 is described in the present embodiment as a communication device that receives services from the SP 600, the UT 500 need not be a terminal unit physically operated by the user, and may instead be a server such as a proxy server.

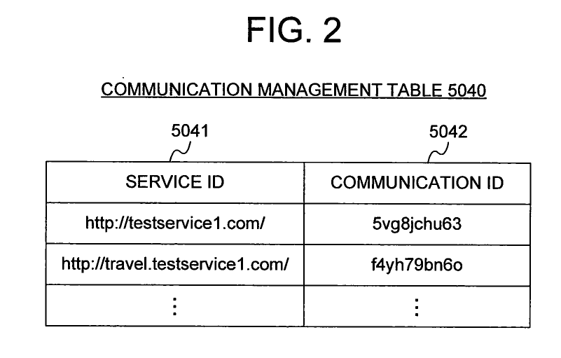

The communication unit 501 communicates with other devices via the network 11 according to instructions from the communication application 502 or the SIP client 503. The communication management table storage unit 504 stores a communication management table 5040 like that shown in FIG. 2, for example. The communication management table 5040 stores a communication ID 5042, created by the SIP client 503, for every service ID 5041 specifying a service currently being provided.

In the present embodiment, the service ID 5041 stores, for example, the URL (Uniform Resource Locator) of an SP 600 that provides the service specified by the service ID 5041. In addition, in the present embodiment, for example, a Call_ID used for SIP communication is used as the communication ID 5042.

The SIP client 503 is a functional block that executes control communication. The SIP client 503 executes authentication process with the CMS 300 via the communication unit 501 according to user instructions input via an input device connected to the UT 500. In addition, the SIP client 503 executes SIP-prescribed location registration process with the CMS 300 via the communication unit 501 according to user instructions.

Location registration process refers to process for registering a combination of location information and SIP-URI (Uniform Resource Identifier) of the UT 500, in a SIP server. The location information may be an IP address, for example, or the combination of an IP address and a port number. In the present embodiment, the execution of both authentication process and location registration process is called a login. In the present embodiment, the UT 500 and each of the SPs 600 are taken to respectively execute process for logging in to the CMS 300 in advance.

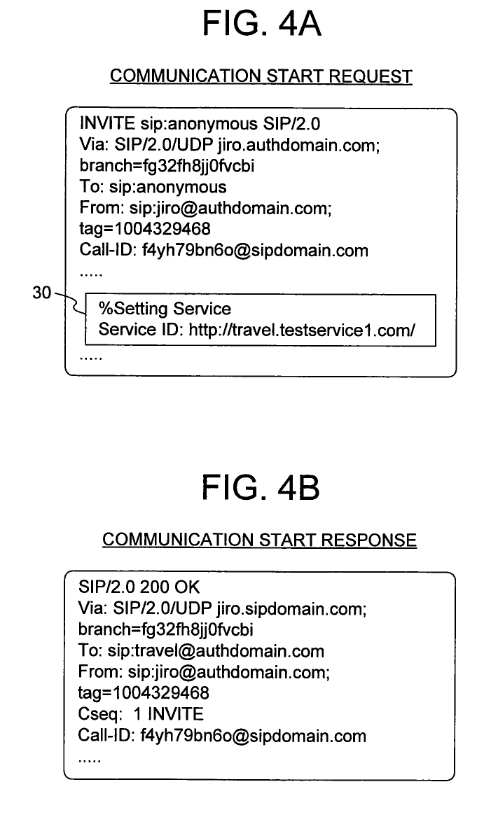

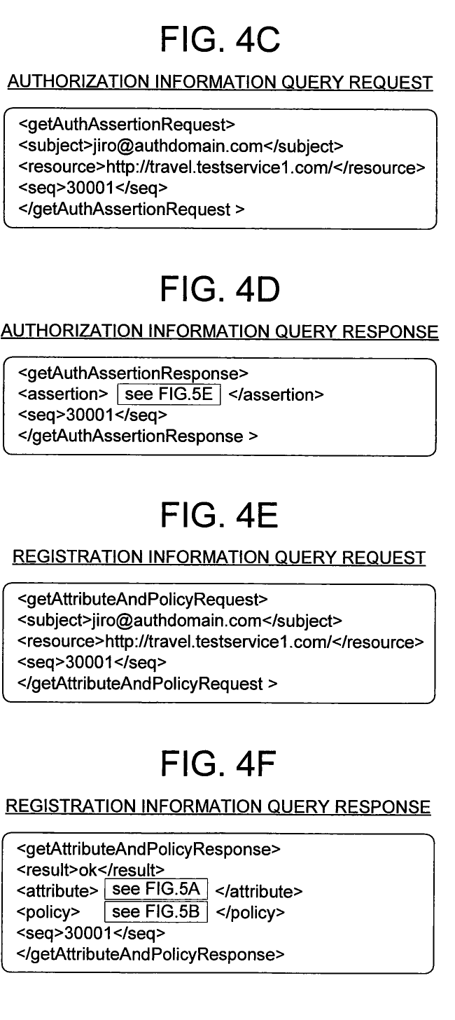

After the login process, if a service ID is received from the communication control engine 505, the SIP client 503 creates a communication start request stating the service ID, and then transmits the created communication start request to the CMS 300 via the communication unit 501. In the present embodiment, the communication start request may be created, for example, using a message format similar to the INVITE request defined in SIP as shown in FIG. 4A. In the BODY portion 30 of the communication start request, the service ID notified from the communication control engine 505 is specified.

Although the user specifies the URL of the SP 600 that provides the service, the SIP-URI of the destination SP 600 is unknown, and for this reason the SIP client 503 creates a communication start request using “anonymous” as the destination SIP-URI.

In addition, upon receiving an initiate communication response from the CMS 300 via the communication unit 501, the SIP client 503 sends the Call_ID specified in the initiate communication response and the service ID specified in the initiate communication request corresponding to the communication start response to the communication control engine 505, together with information indicating that a communications link has been established. In the present embodiment, the communication start response may be created, for example, by the CMS 300 using a message format similar to the 200 OK response defined in SIP as shown in FIG. 4B.

In addition, when communication is terminated as a result of receiving a BYE request from the CMS 300, the SIP client 503 sends the Call_ID contained in the BYE request to the communication control engine 505, together with information indicating the termination of the communication.

In addition, upon being instructed by a user to modify user attribute information, the SIP client 503 creates a registration information update request, and then transmits the created registration information update request to the CMS 300 via the communication unit 501. Subsequently, the SIP client 503 acknowledges that the user attribute information has been successfully modified by receiving a registration information update response from the CMS 300.

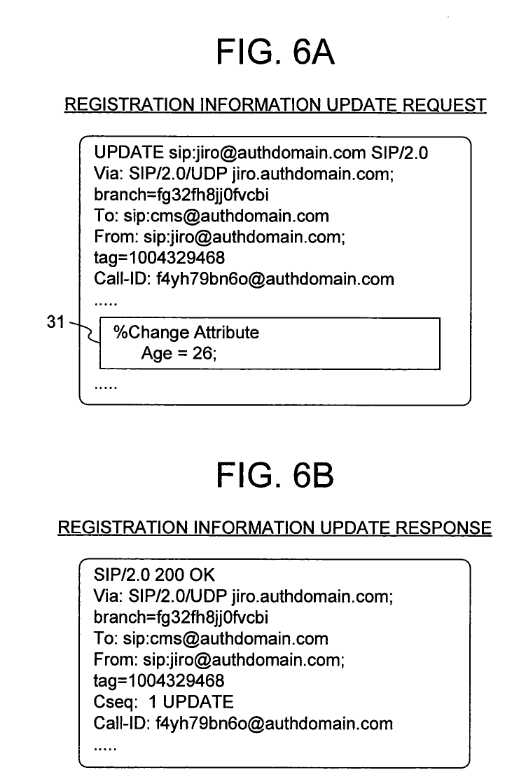

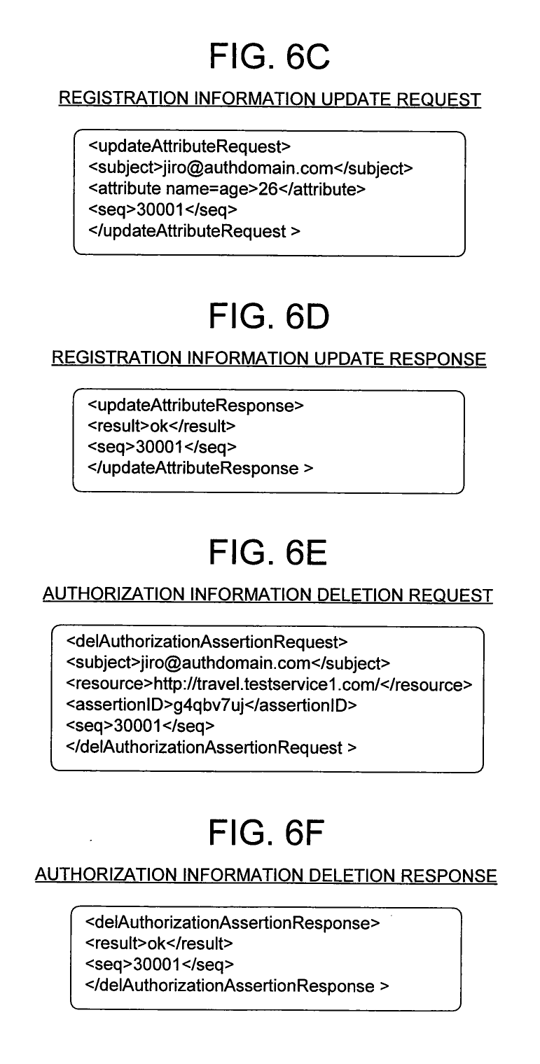

In the present embodiment, the registration information update request may be created, for example, using a message format similar to the update request defined in SIP as shown in FIG. 6A. In the BODY portion 31 of the registration information update request, the user attribute information to be modified as instructed by the user is specified. In the present embodiment, the registration information update response may created, for example, by the CMS 300 using a message format similar to the 200 OK response defined in SIP as shown in FIG. 6B.

Upon receiving a service ID from the communication application 502, the communication control engine 505 refers to the communication management table storage unit 504 and determines whether or not the service ID is registered in the communication management table 5040. If the service ID is registered in the communication management table 5040, the communication control engine 505 replies to the communication application 502 with information indicating that a communications link has been established.

If the service ID is not registered in the communication management table 5040, the communication control engine 505 sends the service ID to the SIP client 503, thereby causing the SIP client 503 to establish a communications link with the SP 600 having the URL indicated in the service ID.

Subsequently, upon receiving a Call_ID and service ID from the SIP client 503 together with information indicating that a communications link has been established, the communication control engine 505 registers a combination of a communication ID and a service ID in the communication management table 5040, using the received Call_ID as the communication ID. Subsequently, the communication control engine 505 notifies the communication application 502 of information indicating that a communications link has been established.

In addition, upon receiving a Call_ID from the SIP client 503 together with information indicating the termination of communication, the communication control engine 505 deletes both the communication ID corresponding to the Call_ID as well as the service ID associated with the communication ID from the communication management table 5040.

The communication application 502 is a functional block that executes data communication. Upon receiving a service request from a user, the communication application 502 sends the service ID corresponding to the service to the communication control engine 505. Subsequently, upon receiving a notification from the communication control engine 505 indicating that a communications link for receiving provision of the service corresponding the service ID has been established, the communication application 502 accesses the SP 600 corresponding to the URL indicated in the service ID and receives the corresponding service.

Next, the SP 600 will be described. The SP 600 is provided with a communication unit 601, a service application 602, a SIP client 603, a communication management table storage unit 604, and a communication control engine 605. The communication unit 601 communicates with other devices via the network 11 according to instructions from the service application 602 or the SIP client 603.

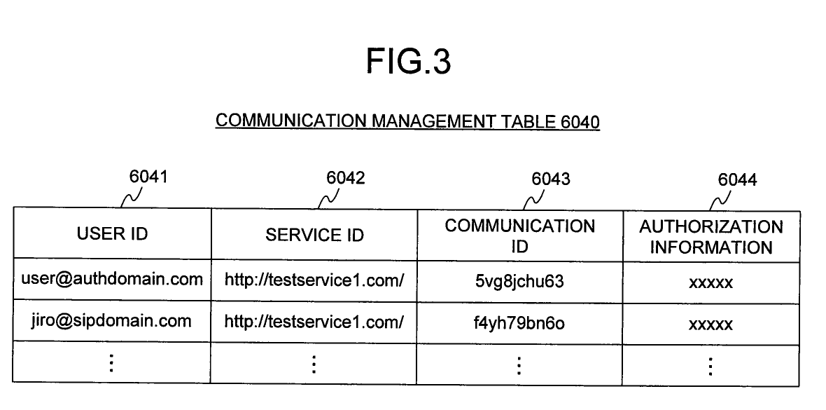

The communication management table storage unit 604 stores a communication management table 6040 like that shown in FIG. 3, for example. The communication management table 6040 stores, for each user ID 6041 specifying a user, a service ID 6042 specifying the service permitted to be provided to the user, a communication ID 6043 specifying the communications link used when providing the service, and authorization information 6044 indicating that provision of the service to the user is permitted.

The SIP client 603 is a functional block that executes control communication. The SIP client 603 logs in to the CMS 300 via the communication unit 601 by executing authentication process and location registration process according to administrator instructions input via an input device connected to the SP 600.

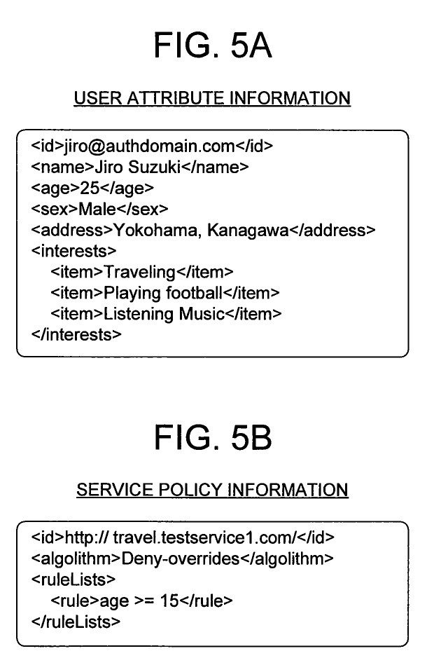

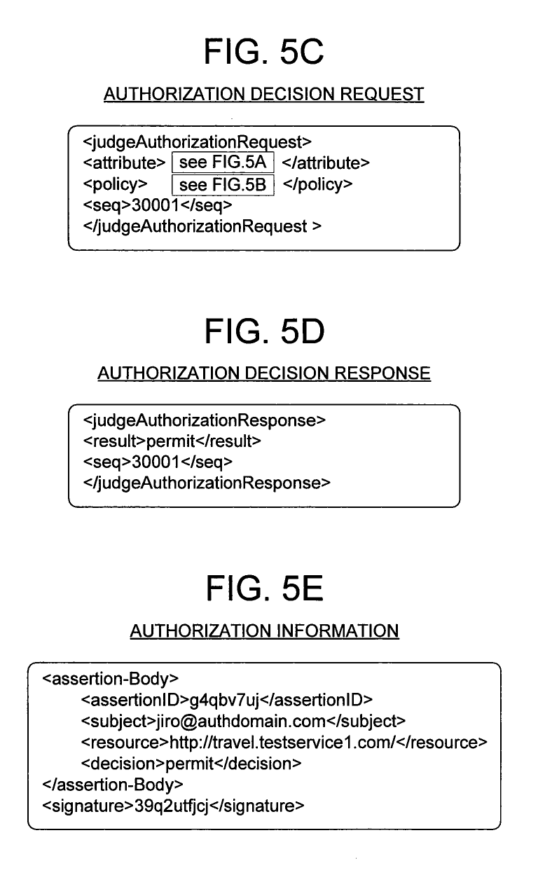

Subsequently, upon receiving from the CMS 300 an initiate communication request (see FIG. 4A) containing authorization information in the format shown in FIG. 5E in the BODY portion 30 thereof, the SIP client 603 sends to the communication control engine 605 the transmission source user ID, the service ID, the communication ID, and the authorization information contained in the initiate communication request. Subsequently, the SIP client 603 creates the initiate communication response shown in FIG. 4B, and then transmits the created initiate communication response to the CMS 300 via the communication unit 601.

In addition, when communication is terminated as the result of receiving a BYE request, the SIP client 603 sends the Call_ID contained in the BYE request to the communication control engine 605, together with information indicating the termination of the communication.

In addition, upon receiving an authorization information deletion request from the ACS 100 via the communication unit 601, the SIP client 603 deletes the entire record corresponding to the user ID contained in the authorization information deletion request from the communication management table 6040. Subsequently, the SIP client 603 creates an authorization information deletion response containing the deletion result, and then transmits the created authorization information deletion response to the ACS 100 via the communication unit 601.

In the present embodiment, the authorization information deletion request is created as an XML message using a “delAuthorizationAssertionRequest” tag, as shown by way of example in FIG. 6E. FIG. 6E shows only the portions of the authorization information deletion request necessary for describing the present embodiment. The user ID is specified in the “subject” tag. The service ID is specified in the “resource” tag. A request number for associating an authorization information deletion request with an authorization information deletion response is specified in the “seq” tag.

In addition, in the present embodiment, the authorization information deletion response is created as an XML message using a “delAuthorizationAssertionResponse” tag, as shown by way of example in FIG. 6F. FIG. 6F shows only the portions of the authorization information deletion response necessary for describing the present embodiment. The result of the deletion of the authorization information is specified in the “result” tag. A request number for associating an authorization information deletion request with an authorization information deletion response is specified in the “seq” tag.

Upon receiving authorization information from the SIP client 603, if the received authorization information indicates that provision of the service is permitted, the communication control engine 605 registers the authorization information in the communication management table 6040, together with the user ID, the service ID, and the communication ID that were received with the authorization information. In addition, upon receiving a Call_ID from the SIP client 603 together with information indicating the termination of the communication, the communication control engine 605 deletes the communication ID corresponding to the Call_ID from the communication management table 6040, together with the user ID, service ID, and authorization information associated with the communication ID.

In addition, upon receiving a combination of a user ID and a service ID from the service application 602, the communication control engine 605 determines whether or not the combination of the user ID and the service ID exists in the communication management table 6040. If the combination of the user ID and the service ID does exist in the communication management table 6040, then the communication control engine 605 replies to the service application 602 with information indicating that the service corresponding to the service ID is permitted to be provided to the user corresponding to the user ID. If the combination of the user ID and the service ID does not exist in the communication management table 6040, then the communication control engine 605 replies to the service application 602 with information indicating that the service corresponding to the service ID is not permitted to be provided to the user corresponding to the user ID.

The service application 602 is a functional block that executes data communication. Upon receiving, via the communication unit 601, a service provision request containing a service ID and the user ID of the user to be provided with the service corresponding to the service ID, the service application 602 sends the user ID and the service ID to the communication control engine 605. Subsequently, upon receiving a reply from the communication control engine 605 indicating that the service corresponding to the service ID is not permitted to be provided to the user corresponding to the user ID, the service application 602 replies, via the communication unit 601, to the UT 500 being used by the user corresponding to the user ID with information indicating the above.

On the other hand, upon receiving a reply from the communication control engine 605 indicating that the service corresponding to the service ID is permitted to be provided to the user corresponding to the user ID, the service application 602 commences provision of the service corresponding to the service ID to the user corresponding to the user ID.

Next, the CMS 300 will be described. The CMS 300 is provided with a location information storage unit 301, a login processor 302, an access history storage unit 303, a SIP message controller 304, and a communication unit 305. The communication unit 305 communicates with other devices via the network 11 according to instructions from the login processor 302 or the SIP message controller 304.

The login processor 302 executes login-related process with respect to the UT 500 and the SP 600, including location registration process and authentication process. The login processor 302 also registers combinations of a SIP-URI and location information received as part of location registration in the location information storage unit 301. It should be appreciated that although in the present embodiment the CMS 300 is provided with both a location information storage unit 301 and a login processor 302, in other embodiments the location information storage unit 301 and the login processor 302 may also be realized by devices external to the CMS 300.

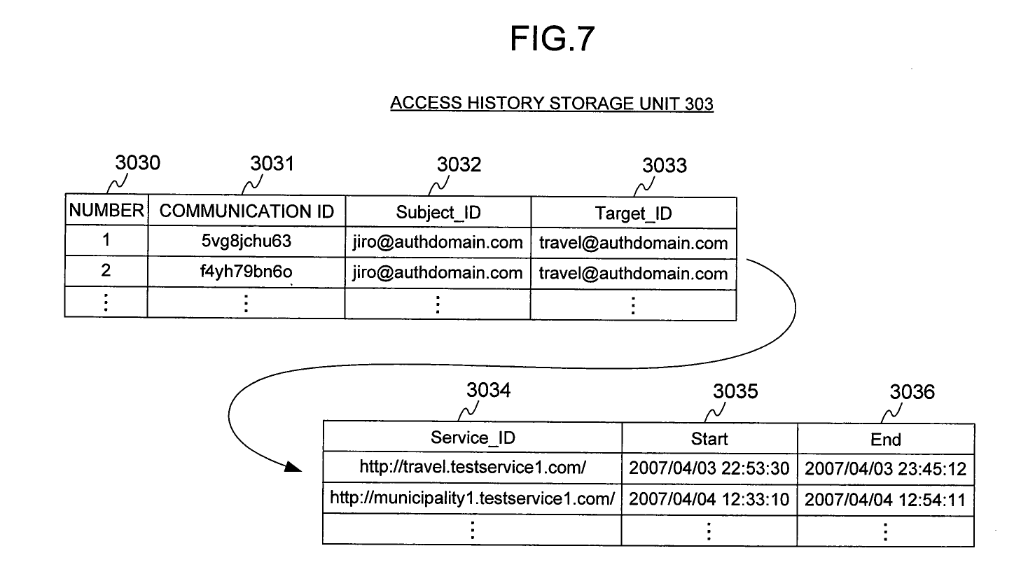

As shown by way of example in FIG. 7, the access history storage unit 303 stores a communication ID 3031 specifying the Call_ID for SIP communication, a Subject_ID 3032 specifying the SIP-URI of the user of the UT 500, a Target_ID 3033 specifying the SIP-URI of the SP 600 that provides the service, a Service_ID 3034 specifying the service ID, a Start 3035 specifying the date and time when SIP communication is commenced, and an End 3036 specifying the date and time when SIP communication is terminated. The above values are respectively associated with a number 3030 that identifies the record containing the values.

Upon receiving the communication start request shown in FIG. 4A from the UT 500 via the communication unit 305, the SIP message controller 304 refers to an external DNS server or similar server to specify the location information (i.e., the IP address) of the SP 600 corresponding to the URL that was specified by the service ID stated in the BODY portion 30 of the communication start request. The SIP message controller 304 then extracts the SIP-URI corresponding to the specified location information from the location information storage unit 301.

Subsequently, the SIP message controller 304 creates and stores a record in the access history storage unit 303. In the record, the value of the communication ID is taken to be the Call_ID contained in the communication start request, the value of the Subject_ID is taken to be the SIP-URI of the transmission source contained in the communication start request, the value of the Target_ID is taken to be the SIP-URI specified on the basis of the service ID contained in the communication start request, and the value of the Service_ID is taken to be the service ID contained in the communication start request. The above values are stored in association with a newly-allocated number.

Subsequently, the SIP message controller 304 creates an authorization information query request, and then transmits the created authorization information query request to the ACS 100 via the communication unit 305. In the present embodiment, the authorization information query request is created as an XML message using a “getAuthAssertionRequest” tag, as shown in FIG. 4C. FIG. 4C shows only the portions of the authorization information query request necessary for describing the present embodiment. The SIP-URI of the UT 500 is specified in the “subject” tag. The service ID is specified in the “resource” tag. A request number for associating an authorization information query request with an authorization information query response is specified in the “seq” tag.

In addition, upon receiving an authorization information query response from the ACS 100 via the communication unit 305, the SIP message controller 304 creates a communication start request (see FIG. 4A) containing authorization information in the format shown in FIG. 5E in the BODY portion 30 thereof, and then transmits the created communication start request to the SP 600 via the communication unit 305. In the present embodiment, the authorization information query response is created as an XML message using a “getAuthAssertionResponse” tag, as shown in FIG. 4D. FIG. 4D shows only the portions of the authorization information query response necessary for describing the present embodiment. The authorization information (see FIG. 5E) is specified in the “assertion” tag. A request number for associating an authorization information query request with an authorization information query response is specified in the “seq” tag.

In addition, upon receiving a communication start response from the SP 600 via the communication unit 305, the SIP message controller 304 refers to the access history storage unit 303 and specifies the record wherein a communication ID identical to the Call_ID contained in the communication start response, a Subject_ID identical to the transmission source SIP-URI contained in the communication start response, and a Target_ID identical to the destination SIP-URI contained in the communication start response are associated together. The SIP message controller 304 then registers the date and time when the communication start response was received in the Start field of the specified record. Subsequently, the SIP message controller 304 rewrites a portion of the information in the communication start response (the contents of the “via” header, for example), and then transmits the modified communication start response to the destination UT 500.

In addition, upon receiving a 200 OK response with respect to the BYE request via the communication unit 305, the SIP message controller 304 specifies the record wherein a communication ID identical to the Call_ID contained in the 200 OK response, a Subject_ID identical to the transmission source SIP-URI contained in the 200 OK response, and a Target_ID identical to the destination SIP-URI contained in the 200 OK response are associated together. The SIP message controller 304 then registers the date and time when the 200 OK response was received in the End field of the specified record.

In addition, upon receiving the registration information update request shown in FIG. 6A from the UT 500 via the communication unit 305, the SIP message controller 304 creates a registration information update request in a different format, and then transmits the created registration information update request to the ACS 100 via the communication unit 305. In the present embodiment, the registration information update request created by the SIP message controller 304 is created as an XML message using the “updateAttributeRequest” tag, as shown by way of example in FIG. 6C. FIG. 6C shows only the portions of the registration information update request created by the SIP message controller 304 that are necessary for describing the present embodiment. The SIP-URI of the UT 500 is specified in the “subject” tag. The user attribute information to be updated is specified in the “attribute” tag. A request number for associating a registration information update request with an update registration information response as a response is specified in the “seq” tag.

In addition, upon receiving an registration information update response from the ACS 100 via the communication unit 305, the SIP message controller 304 creates an registration information update response in a different format (see FIG. 6B), and then transmits the created registration information update response to the UT 500 via the communication unit 305. In the present embodiment, the registration information update response transmitted by the ACS 100 is created as an XML message using the “updateAttributeResponse” tag, as shown by way of example in FIG. 6D. FIG. 6D shows only the portions of the registration information update response transmitted by the ACS 100 that are necessary for describing the present embodiment. The user attribute information modification results are specified in the “result” tag. A request number for associating a registration information update request with a registration information update response is specified in the “seq” tag.

Next, the ACS 100 will be described. The ACS 100 is provided with a next service ID storage unit 101, a next service ID specifying unit 102, an authorization information storage unit 103, an authorization decision requesting unit 104, and a communication unit 105. The communication unit 105 communicates with other devices via the network 11 according to instructions from the authorization decision requesting unit 104.

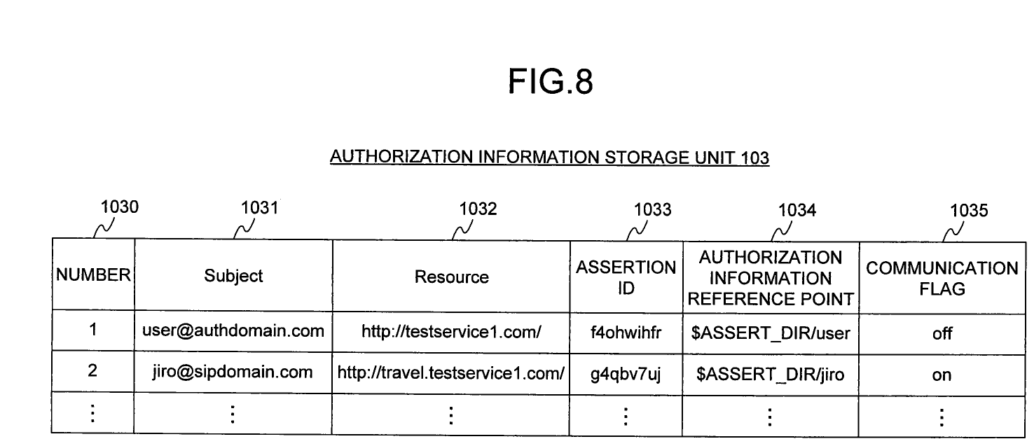

As shown by way of example in FIG. 8, the authorization information storage unit 103 stores a Subject 1031 specifying the SIP-URI of a user of the UT 500, a Resource 1032 specifying a service ID, an assertion ID 1033 specified in the authorization information created by the authorization decision requesting unit 104 (see FIG. 5E), an authorization information reference point 1034 specifying the location where the authorization information is stored, and a communication flag 1035 indicating whether or not the service corresponding to the Resource 1032 is being provided to the user corresponding to the Subject 1031. The above values are respectively stored in the authorization information storage unit 103 in association with a number 1030 that identifies the record containing the values.

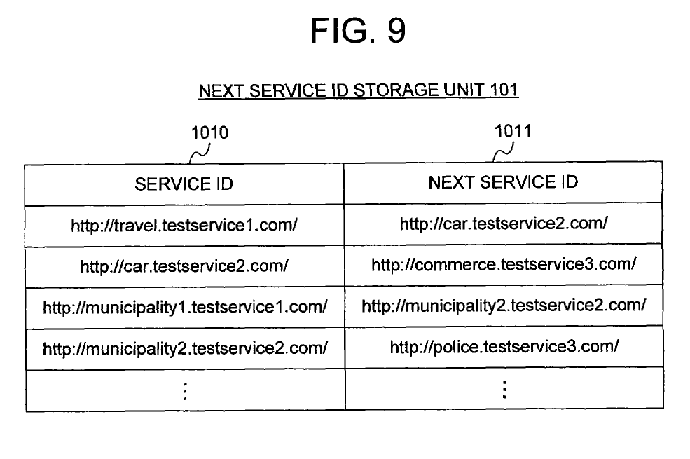

As shown by way of example in FIG. 9, the next service ID storage unit 101 stores, for the respective service ID 1010 of each service, a next service ID 1011 indicating the service ID of the next service to be provided. In the present embodiment, each service constitutes a portion in a predetermined work flow, and thus the order in which services are provided is determined in advance for each work flow.

Upon receiving a user ID and a service ID from the authorization decision requesting unit 104, the next service ID specifying unit 102 refers to the next service ID storage unit 101 and extracts the next service ID associated with the received service ID. Subsequently, the next service ID specifying unit 102 sends the extracted next service ID to the authorization decision requesting unit 104, together with the user ID that was received from the authorization decision requesting unit 104. If a next service ID corresponding to the service ID received from the authorization decision requesting unit 104 does not exist in the next service ID storage unit 101 (such being the case for a service ID for a service to be provided next to the last service in a work flow, for example), then the next service ID specifying unit 102 replies to the authorization decision requesting unit 104 with the user ID received from the authorization decision requesting unit 104.

Upon receiving an authorization information query request (see FIG. 4C) from the CMS 300 via the communication unit 105, the authorization decision requesting unit 104 refers to the authorization information storage unit 103, and determines whether or not there exists authorization information corresponding to the combination of the user ID specified in the “subject” tag, and the service ID specified in the “resource” tag, of the authorization information query request. If authorization information corresponding to the combination of the user ID and the service ID does exist, then the authorization decision requesting unit 104 acquires the authorization information from the authorization information storage unit 103, creates an authorization information query response as described with reference to FIG. 4D, and then transmits the created authorization information query response to the CMS 300 via the communication unit 105.

If authorization information corresponding to the combination of the user ID and the service ID contained in the authorization information query request does not exist in the authorization information storage unit 103, then the authorization decision requesting unit 104 creates an registration information query request, and then transmits the created registration information query request to the PMS 200 via the communication unit 105. In the present embodiment, the registration information query request is created as an XML message using the “getAttributeAndPolicyRequest” tag, as shown in FIG. 4E. FIG. 4E shows only the portions of the registration information query request necessary for describing the present embodiment. The SIP-URI of the UT 500 is specified in the “subject” tag. The service ID is specified in the “resource” tag. A request number for associating a registration information query request with a registration information query response is specified in the “seq” tag.

Subsequently, upon receiving a registration information query response from the PMS 200 via the communication unit 105, the authorization decision requesting unit 104 creates an authorization decision request, and then transmits the created authorization decision request to the AuS 400 via the communication unit 105. In the present embodiment, the registration information query response is created as an XML message using the “getAttributeAndPolicyResponse” tag, as shown in FIG. 4F. FIG. 4F shows only the portions of the registration information query response necessary for describing the present embodiment.

The result of acquiring the attribute information of the user of the UT 500 and the service policy information is stated in the “result” tag of the registration information query response. The acquisition result may, for example, state “OK” in the case where both the user attribute information and the service policy information are acquired, or “NG” in the case where either one of the user attribute information or the service policy information is not acquired. A request number for associating a registration information query request with a registration information query response is specified in the “seq” tag of the registration information query response.

The user attribute information is specified in the “attribute” tag of the registration information query response. The user attribute information is described as an XML message, as shown by way of example in FIG. 5A. The SIP-URI of the user is specified in the “id” tag of the attribute information. The name of the user is specified in the “name” tag. The age of the user is specified in the “age” tag. The sex of the user is specified in the “sex” tag. The address of the user is specified in the “address” tag. The user's interests are specified in the “interests” tag, each interest being respectively enclosed by “item” tags. At least one “item” tag is specified. Tag elements other than the “id” tag are optional, and “null” is specified in the element of each tag where no value is specified.

The service policy information is specified in the “policy” tag of the registration information query response. The service policy information is described as an XML message, as shown by way of example in FIG. 5B. The service ID is specified in the “id” tag. Rules acting as the criteria whereby an authorization decision is made are specified in the “ruleLists” tag and enclosed by “rule” tags. The name of the algorithm used to make an authorization decision using the rules specified in the “ruleLists” tag is specified in the “algorithm” tag. At least one “rule” tag is specified. In addition, tag elements other than the “id” are optional, and “null” is specified in the element of each tag where no value is specified.

In the present embodiment, two types of authorization decision algorithms are supposed as examples of usable authorization decision algorithms. Thus, algorithms like the following two algorithms are specifiable in the elements of the “algorithm” tag stated in the service policy information. “Deny-overrides” is an authorization decision algorithm that makes a decision with respect to all rules, returning an authorization decision result of “Permit” only in the case where “Permit” is returned for all rules, and returning an authorization decision result of “Deny” for all other cases. “Permit-overrides” is an authorization decision algorithm that makes a decision with respect to all rules, returning an authorization decision result of “Permit” when “Permit” is returned for any single rule, and returning an authorization result of “Deny” only in the case where “Deny” is returned for all rules. When a service is used that does not require an authorization decision, “null” is specified as the authorization decision algorithm.

In addition, in the present embodiment, the authorization decision request is created as an XML message using the “judgeAuthorizationRequest” tag, as shown in FIG. 5C. FIG. 5C shows only the portions of the authorization decision request necessary for describing the present embodiment. The user attribute information is specified in the “attribute” tag. The service policy information is specified in the “policy” tag. A request number for associating an authorization decision request with an authorization decision response is specified in the “seq” tag.

Subsequently, upon receiving an authorization decision response from the AuS 400 via the communication unit 105, the authorization decision requesting unit 104 creates authorization information. In the present embodiment, the authorization decision response is created as an XML message using the “judgeAuthorizationResponse” tag, as shown in FIG. 5D. FIG. 5D shows only the portions of the authorization decision response necessary for describing the present embodiment. The authorization decision result is specified in the “result” tag. A request number for associating an authorization decision request with an authorization decision response is specified in the “seq” tag.

Subsequently, if the authorization decision result contained in the authorization decision response indicates that provision of the service is permitted, then the authorization decision requesting unit 104 saves the created authorization information in memory in the ACS 100 or in memory in a device external to the ACS 100. The authorization decision requesting unit 104 also registers information indicating the saved location in authorization information storage unit 103 and in association with the user ID and the service ID subject to the authorization information. Subsequently, the authorization decision requesting unit 104 creates an authorization information query response (see FIG. 4D), and then transmits the created authorization information query response to the CMS 300 via the communication unit 105.

In the present embodiment, the authorization information is created as an XML message using the “assertion-Body” tag, as shown in FIG. 5E. FIG. 5E shows only the portion of the authorization information necessary for describing the present embodiment. Identification information identifying the authorization information is specified in the “assertionID” tag. The user ID contained in the user attribute information in the authorization decision request corresponding to the authorization decision response is specified in the “subject” tag. The service ID contained in the service policy information in the authorization decision request corresponding to the authorization decision response is specified in the “resource” tag. The result of the authorization decision contained in the authorization decision response is specified in the “decision” tag. An XML signature applying to the entire “assertion-Body” tag is specified in the “signature” tag.

After transmitting the authorization information query response to the CMS 300, the authorization decision requesting unit 104 sends the user ID and the service ID contained in the authorization information query response to the next service ID specifying unit 102. Subsequently, upon receiving the user ID and the next service ID from the next service ID specifying unit 102, the authorization decision requesting unit 104 determines whether or not authorization information corresponding to the combination of the user ID and the next service ID is registered in the authorization information storage unit 103.

If authorization information corresponding to the combination of the user ID and the next service ID is not registered in the authorization information storage unit 103, then the authorization decision requesting unit 104 creates an registration information query request (see FIG. 4E) containing the user ID and the next service ID, and then sends the created registration information query request to the PMS 200. If authorization information corresponding to the combination of the user ID and the next service ID is already registered in the authorization information storage unit 103, or alternatively, if the next service ID specifying unit 102 does not output a next service ID together with the user ID, then the authorization decision requesting unit 104 does not execute the process to make an authorization decision in advance.

Subsequently, the authorization decision requesting unit 104 receives a registration information query response (FIG. 4F) from the PMS 200, creates an authorization decision request (FIG. 5C) on the basis of the received registration information query response, and then sends the created authorization decision request to the AuS 400. Subsequently, the authorization decision requesting unit 104 receives an authorization decision response (FIG. 5D) from the AuS 400. If the authorization decision result contained in the received authorization decision response indicates that provision of the service is permitted, then the authorization decision requesting unit 104 creates authorization information, saves the created authorization information in memory in the ACS 100 or in memory in a device external to the ACS 100, and then registers information indicating the saved location in the authorization information storage unit 103 and in association with the user ID and the service ID subject to the authorization information.

In this way, the authorization decision requesting unit 104 executes process to make an authorization decision regarding the next service to be provided after a service that has been authorized for a particular user before the user requests the next service. In so doing, when a service request is received from a user in the access authorization system 10, provision of the service based on an authorization decision result with respect to the user can be commenced promptly and without making the user wait while the authorization decision is being made.

In the present embodiment, during the time between when the authorization decision requesting unit 104 transmits an authorization information query response to the CMS 300 and when the authorization decision requesting unit 104 receives from the CMS 300 an authorization information query request with respect to the next service to be provided after the service that was specified by the service ID stated in the authorization information query response, the authorization decision requesting unit 104 executes process related to making an authorization decision with respect to the next service to be provided to the user corresponding to the user ID contained in the authorization information query response.

More preferably, during the time between when the authorization decision requesting unit 104 transmits an authorization information query response to the CMS 300 and when the authorization decision requesting unit 104 receives from the CMS 300 an authorization information query request with respect to the next service to be provided after the service that was specified by the service ID stated in the authorization information query response, the authorization decision requesting unit 104 performs process to make an authorization decision with respect to the next service to be provided when the ACS 100 is under a low process load. A low process load herein refers to a state wherein, for example, the process load on the ACS 100 is lower than a predetermined threshold value. For example, the authorization decision requesting unit 104 may perform process to make an authorization decision with respect to the next service to be provided when the ratio of CPU usage of the ACS 100 is less than 50%.

In addition, upon receiving a registration information update request (see FIG. 6C) from the CMS 300 via the communication unit 105, the authorization decision requesting unit 104 forwards the received registration information update request to the PMS 200. Subsequently, upon receiving an registration information update response (see FIG. 6D) from the PMS 200, the authorization decision requesting unit 104 refers to the authorization information storage unit 103 and determines whether or not the user ID contained in the registration information update request corresponding to the registration information update response is registered in the authorization information storage unit 103. If the user ID is not registered in the authorization information storage unit 103, then the authorization decision requesting unit 104 forwards the registration information update response received from the PMS 200 to the CMS 300.

On the other hand, if the user ID contained in the registration information update request corresponding to the registration information update response received from the PMS 200 is registered in the authorization information storage unit 103, then the authorization decision requesting unit 104 refers to the authorization information storage unit 103 and extracts the service IDs associated with the user ID. Subsequently, the authorization decision requesting unit 104 creates authorization information deletion requests (see FIG. 6E) with respect to each extracted service ID, and then transmits the created authorization information deletion requests to their respective destination SPs 600 via the communication unit 105.

Subsequently, upon receiving authorization information deletion response (FIG. 6F) from all of the SPs 600 to which the authorization information deletion requests were sent, the authorization decision requesting unit 104 deletes, from the authorization information storage unit 103, all of the records containing the user ID contained in the transmitted authorization information deletion requests. The authorization decision requesting unit 104 then forwards the registration information update response received from the PMS 200 to the CMS 300.

Next, the PMS 200 will be described. The PMS 200 is provided with a service policy information storage unit 201, a user attribute information storage unit 202, an information management unit 203, and a communication unit 204. The communication unit 204 communicates with other devices via the network 11 according to instructions from the information management unit 203.

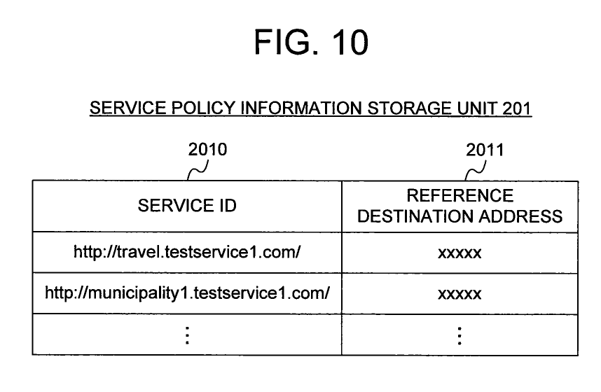

As shown by way of example in FIG. 10, the service policy information storage unit 201 stores, for each service ID 2010, a reference destination address 2011 specifying the location in the memory of the PMS 200 where the actual service policy information for the service corresponding to a particular service ID 2010 is stored. The actual service policy information has a data structure like that shown by way of example in FIG. 5B.

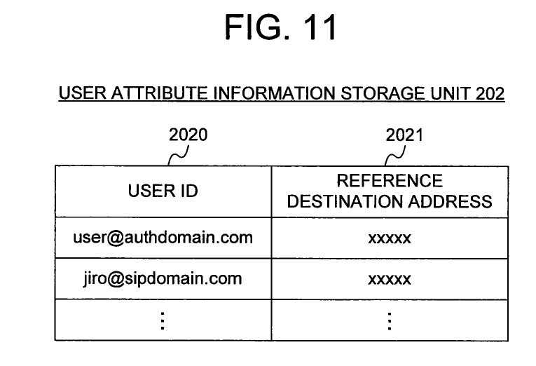

As shown by way of example in FIG. 11, the user attribute information storage unit 202 stores, for each user ID 2020, a reference destination address 2021 specifying the location in the memory of the PMS 200 where the actual user attribute information corresponding to a particular user ID 2020 is stored. The actual user attribute information has a data structure like that shown by way of example in FIG. 5A.

Upon receiving a registration information query request (see FIG. 4E) from the ACS 100 via the communication unit 204, the information management unit 203 acquires, from the service policy information storage unit 201, service policy information corresponding to the service ID contained in the registration information query request. The information management unit 203 also acquires, from the user attribute information storage unit 202, user attribute information corresponding to the user ID contained in the registration information query request. Subsequently, the information management unit 203 creates a registration information query response (see FIG. 4F) on the basis of the acquired service policy information and user attribute information, and then transmits the created registration information query response to the ACS 100 via the communication unit 204.

In addition, upon receiving an registration information update request (see FIG. 6C) from the ACS 100 via the communication unit 204, the information management unit 203 refers to the user attribute information storage unit 202 and updates the user attribute information corresponding to the user ID contained in the registration information update request with the user attribute information contained in the registration information update request. Subsequently, the information management unit 203 creates an registration information update response (FIG. 6D) containing the update result, and then transmits the created registration information update response to the ACS 100 via the communication unit 204.

Next, the AuS 400 will be described. The AuS 400 is provided with an authorization decision unit 401 and a communication unit 402. The communication unit 402 communicates with other devices via the network 11 according to instructions from the authorization decision unit 401.

Upon receiving an authorization decision request (see FIG. 5C) from the ACS 100 via the communication unit 402, the authorization decision unit 401 executes an authorization decision for determining whether or not the user attribute information contained in the authorization decision request satisfies the service policy information contained in the authorization decision request. Subsequently, the authorization decision unit 401 creates an authorization decision response (see FIG. 5D) containing the authorization decision result, and then transmits the created authorization decision response to the ACS 100 via the communication unit 402.

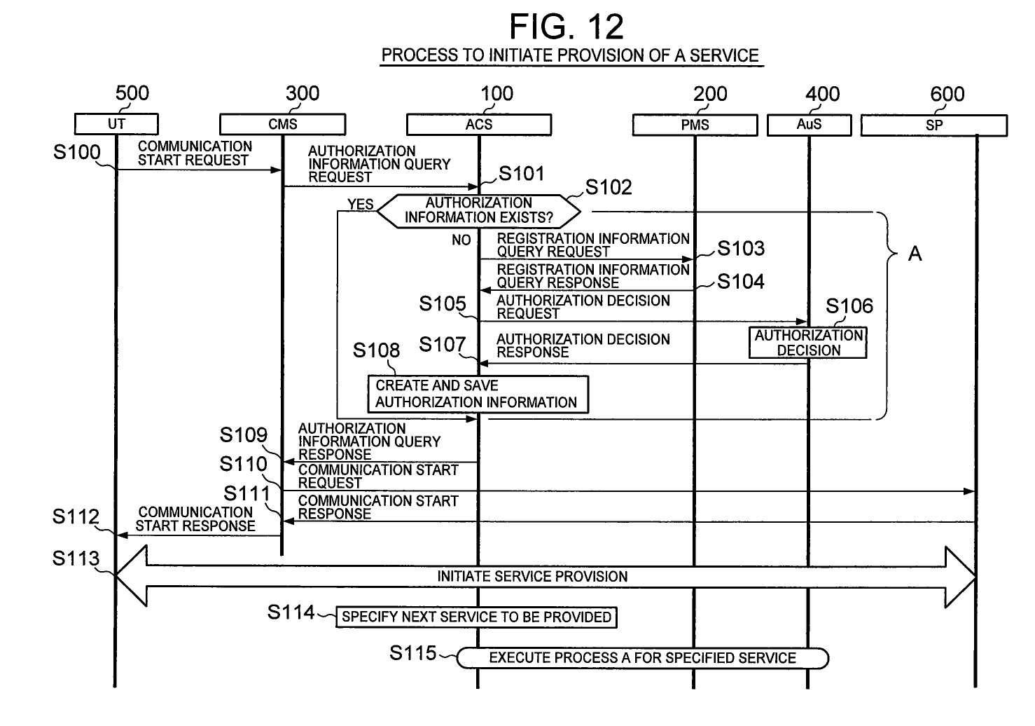

Next, the series of operations conducted by the access authorization system 10 in accordance with the first embodiment in the case where the provision of a service is commenced in response to a user request will be described with reference to FIG. 12.

First, the SIP client 503 of the UT 500 creates the communication start request shown in FIG. 4A according to a request from the user, and then transmits the created communication start request to the CMS 300 (S100). In the present example it is supposed that the SIP-URI of the user of the UT 500 is “jiro@sipdomain.com” and the service ID of the service desired by the user is “http://travel.textservice1.com/”. The SIP message controller 304 of the CMS 300 creates the authorization information query request shown in FIG. 4C on the basis of the communication start request received from the UT 500, and then transmits the created authorization information query request to the ACS 100 (S101).

Next, the authorization decision requesting unit 104 of the ACS 100 determines whether or not authorization information corresponding to the combination of the user ID and the service ID contained in the authorization information query request received from the CMS 300 is stored in the authorization information storage unit 103 (S102). If authorization information corresponding to the combination of the user ID and the service ID is stored in the authorization information storage unit 103 (S102: Yes), then the authorization decision requesting unit 104 executes the process indicated in step S109.

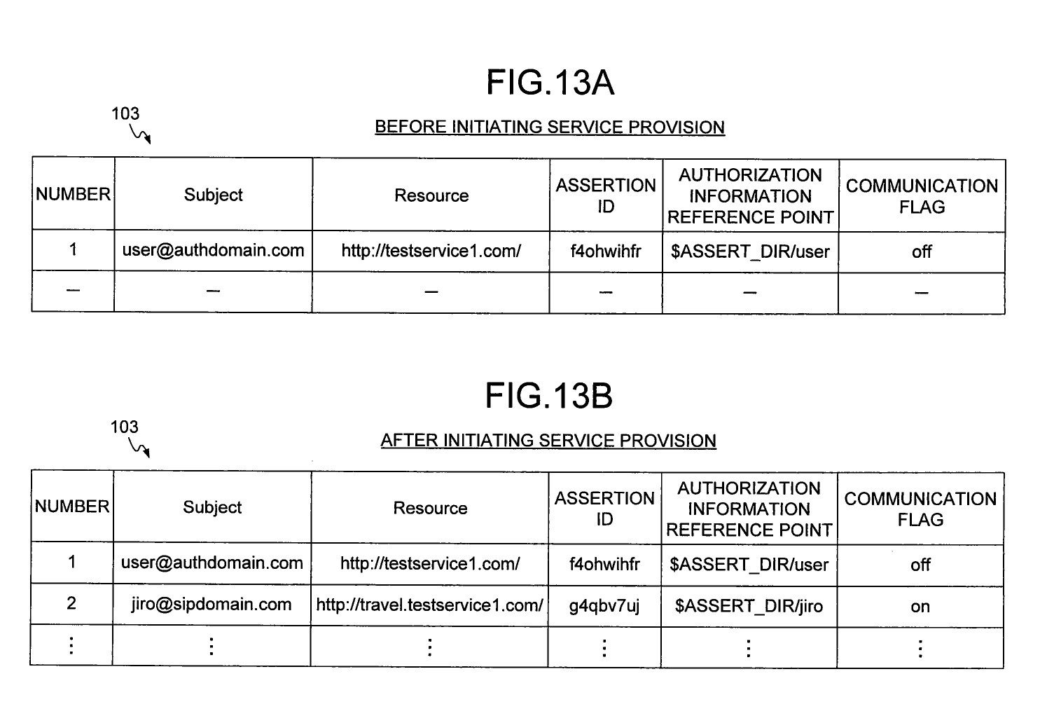

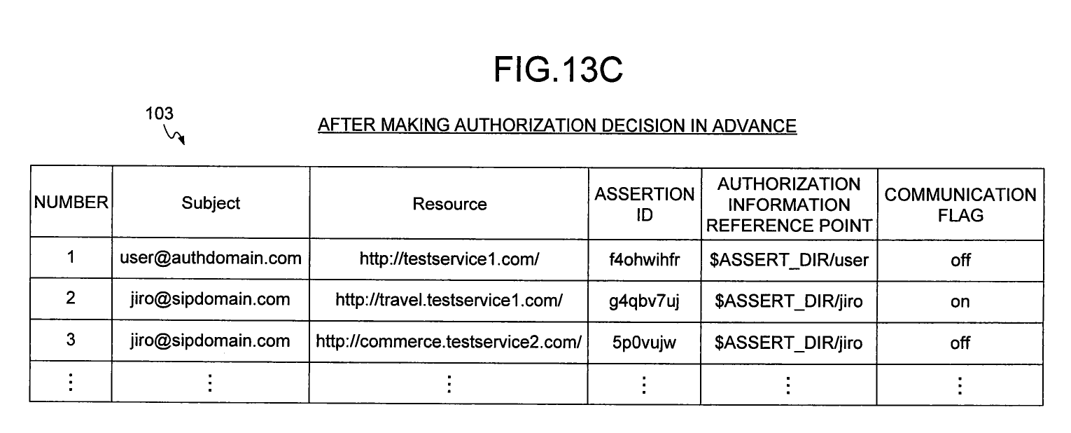

In the above case, data like that shown by way of example in FIG. 13A is taken to be stored in the authorization information storage unit 103 before step S102 is executed. However, in the exemplary sequence shown in FIG. 12, authorization information corresponding to the combination of the user ID and the service ID contained in the authorization information query request received from the CMS 300 is not stored in the authorization information storage unit 103 (S102: No), and as a result the authorization decision requesting unit 104 creates the registration information query request shown in FIG. 4E on the basis of the user ID and the service ID, and then transmits the created registration information query request to the PMS 200 (S103).

The information management unit 203 of the PMS 200 then acquires, on the basis of the user ID and the service ID contained in the registration information query request received from the ACS 100, the corresponding user attribute information and service policy information from the user attribute information storage unit 202 and the service policy information storage unit 201, respectively. Subsequently, the information management unit 203 creates a registration information query response (see FIG. 4F) containing the acquired user attribute information and the service policy information, and then transmits the created registration information query response to the ACS 100 (S104).

Next, the authorization decision requesting unit 104 of the ACS 100 creates an authorization decision request (see FIG. 5C) containing the user attribute information and the service policy information contained in the registration information query response received from the PMS 200, and then transmits the created authorization decision request to the AuS 400 (S105). The authorization decision unit 401 of the AuS 400 then determines whether or not the user attribute information contained in the authorization decision request received from the ACS 100 satisfies the service policy information contained in the authorization decision request (S106). Subsequently, the authorization decision unit 401 creates an authorization decision response (see FIG. 5D) containing the authorization decision result, and then transmits the created authorization decision response to the ACS 100 (S107).

Next, the authorization decision requesting unit 104 of the ACS 100 creates the authorization information shown in FIG. 5E on the basis of the authorization decision response received from the AuS 400. Furthermore, if the authorization decision result contained in the authorization decision response indicates that use of the service is permitted, the authorization decision requesting unit 104 stores the authorization information in the authorization information storage unit 103, together with information such as the corresponding user ID and service ID (S108). At this point, the data in the authorization information storage unit 103 becomes structured like that shown by way of example in FIG. 13B. Subsequently, the authorization decision requesting unit 104 creates the authorization information query response shown in FIG. 4D, and then transmits the created authorization information query response to the CMS 300 (S109).

The SIP message controller 304 of the CMS 300 takes the destination of the communication start request shown in FIG. 4A to be the SIP-URI of the SP 600 that provides the service corresponding to the service ID, and creates a communication start request containing, in the BODY portion 30 thereof, the authorization information contained in the authorization information query response received from the ACS 100. The SIP message controller 304 then transmits the created communication start request to the SP 600 (S110).

The SIP client 603 of the SP 600 creates the communication start response shown in FIG. 4B in response to the initiate communication request received from the CMS 300, and then transmits the created communication start response to the CMS 300 (S111). The SIP message controller 304 of the CMS 300 then rewrites a portion of the communication start response received from the SP 600, and then transmits the modified communication start response to the UT 500 (S112). Subsequently, the service application 602 of the SP 600 initiates provision of the service to the UT 500 (S113).

Next, the authorization decision requesting unit 104 of the ACS 100 sends the user ID and the service ID contained in the authorization information in the authorization information query response that was transmitted in step S109, to the next service ID specifying unit 102. The next service ID specifying unit 102 refers to the next service ID storage unit 101 and specifies the next service ID to be provided by extracting the next service ID associated with the service ID received from the authorization decision requesting unit 104 (S114).

Next, the next service ID specifying unit 102 replies to the authorization decision requesting unit 104 with the extracted next service ID, together with the user ID received from the authorization decision requesting unit 104. Subsequently, the authorization decision requesting unit 104 executes the process A shown from step S102 to step S108, using the user ID and the service ID received from the next service ID specifying unit 102 (S115). When the process of step S115 is completed, the data in the authorization information storage unit 103 becomes structured like that shown by way of example in FIG. 13C. In so doing, when the provision of a next service is requested by the same user, the access authorization system 10 is able to rapidly commence provision of the service on the basis of the authorization information in the authorization information storage unit 103.

It should be appreciated that while the process shown in step S114 and step S115 is executed after the process shown in step S113 in the sequence shown in FIG. 12, the present invention is not limited thereto. The authorization decision requesting unit 104 may also execute the process shown in step S114 and step S115 during the time between when the process shown in step S109 is executed and when an authorization information query request corresponding to a request for the next service is received.

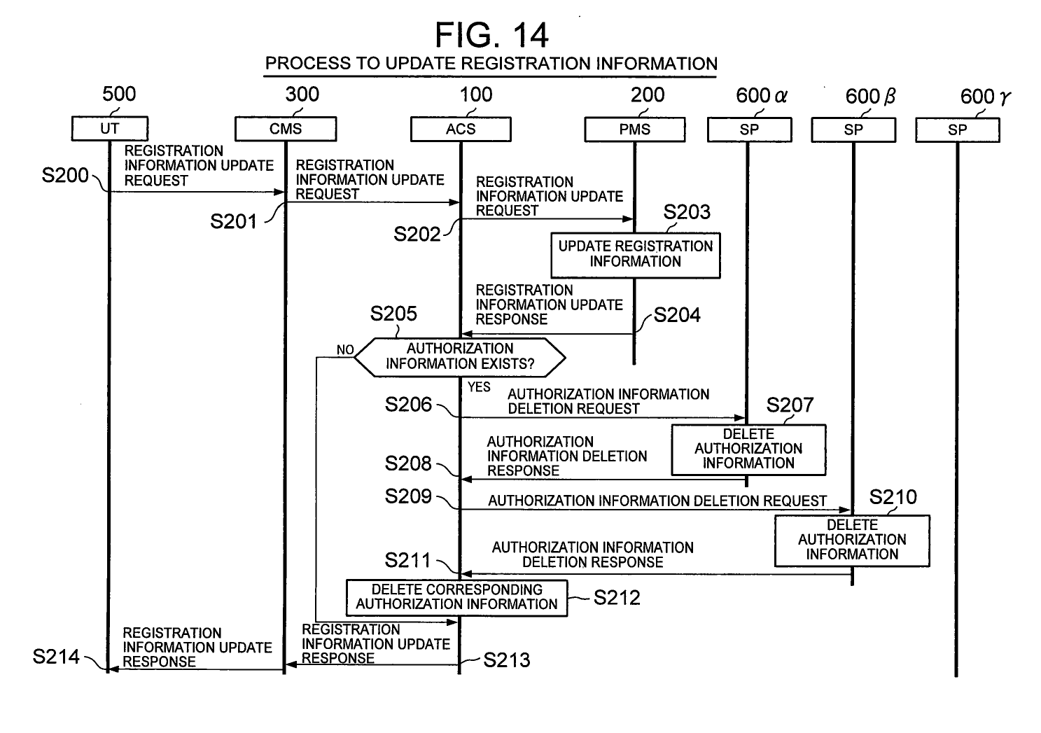

Next, the series of processes related to a user updating registration information via the UT 500 in accordance with the first embodiment will be described with reference to FIG. 14.

First, the SIP client 503 of the UT 500 creates the registration information update request shown in FIG. 6A in response to a request from a user, and then transmits the created registration information update request to the CMS 300 (S200). The SIP message controller 304 of the CMS 300 then creates the registration information update request shown in FIG. 6C on the basis of the registration information update request received from the UT 500, and then transmits the created registration information update request to the ACS 100 (S201).

The authorization decision requesting unit 104 of the ACS 100 forwards the registration information update request received from the CMS 300 to the PMS 200 (S202). The information management unit 203 of the PMS 200 then updates the user attribute information in the user attribute information storage unit 202 corresponding to the user ID contained in the registration information update request received from the ACS 100 with the user attribute information contained in the registration information update request. (S203). Subsequently, the information management unit 203 creates the registration information update response shown in FIG. 6D, and then transmits the created registration information update response to the ACS 100 (S204).

Next, the authorization decision requesting unit 104 of the ACS 100 determines whether or not authorization information corresponding to the user ID contained in the registration information update request received in step S201 is stored in the authorization information storage unit 103 (S205). If authorization information corresponding to the user ID is not stored in the authorization information storage unit 103 (S205: No), then the authorization decision requesting unit 104 executes the process shown in step S213.

If authorization information corresponding to the user ID contained in the registration information update request received in step S201 is stored in the authorization information storage unit 103 (S205: Yes), then the authorization decision requesting unit 104 extracts the service IDs associated with the authorization information from the authorization information storage unit 103, creates the authorization information deletion request shown in FIG. 6E for each extracted service ID, and then transmits the created authorization information deletion requests (S206, S209). In the present example, it is supposed that authorization information indicating that provision of a service is permitted has already been passed to a SP 600-α and a SP 600-β, while authorization information indicating that provision of a service is permitted has not been passed to a SP 600-γ.

The respective SIP clients 603 of the SP 600-α and the SP 600-β respectively refer to the communication management table storage unit 604 and delete, from the communication management table 6040, all records corresponding to the user ID contained in the authorization information deletion request received from the ACS 100 (S207, S210). Subsequently, each SIP client 603 creates the authorization information deletion response shown in FIG. 6F, and then transmits the created authorization information deletion response to the ACS 100 (S208, S211).

Next, the authorization decision requesting unit 104 of the ACS 100 deletes, from the authorization information storage unit 103, all authorization information corresponding to the user ID contained in the registration information update request received in step S201 (S212), and then forwards the registration information update response received in step S204 to the CMS 300 (S213). The SIP message controller 304 of the CMS 300 then creates the registration information update response shown in FIG. 6B on the basis of the registration information update response received from the ACS 100, and then transmits the created registration information update response to the UT 500 (S214).

Hereinabove, the first embodiment of the present invention has been described. As is clear from the foregoing description, according to the access authorization system 10 of the present embodiment, the user wait time until the provision of a user-request service commences is reduced.

In addition, in the present embodiment, the ACS 100 retains the results of previously-conducted authorization decisions, and when an authorization information query request is received from the CMS 300, the ACS 100 replies with an authorization information query response using the retained authorization information. In so doing, authorization information related a service that has not actually been provided to the user is saved in the ACS 100. For this reason, although it is necessary to execute process to delete authorization information as part of the reevaluation of the authorization decision when the user attribute information is modified, the number of devices wherein the authorization information is saved can be reduced, and thus the communication traffic involved in the deletion of the authorization information can be decreased.

### Embodiment 2

Next, a second embodiment of the present invention will be described.

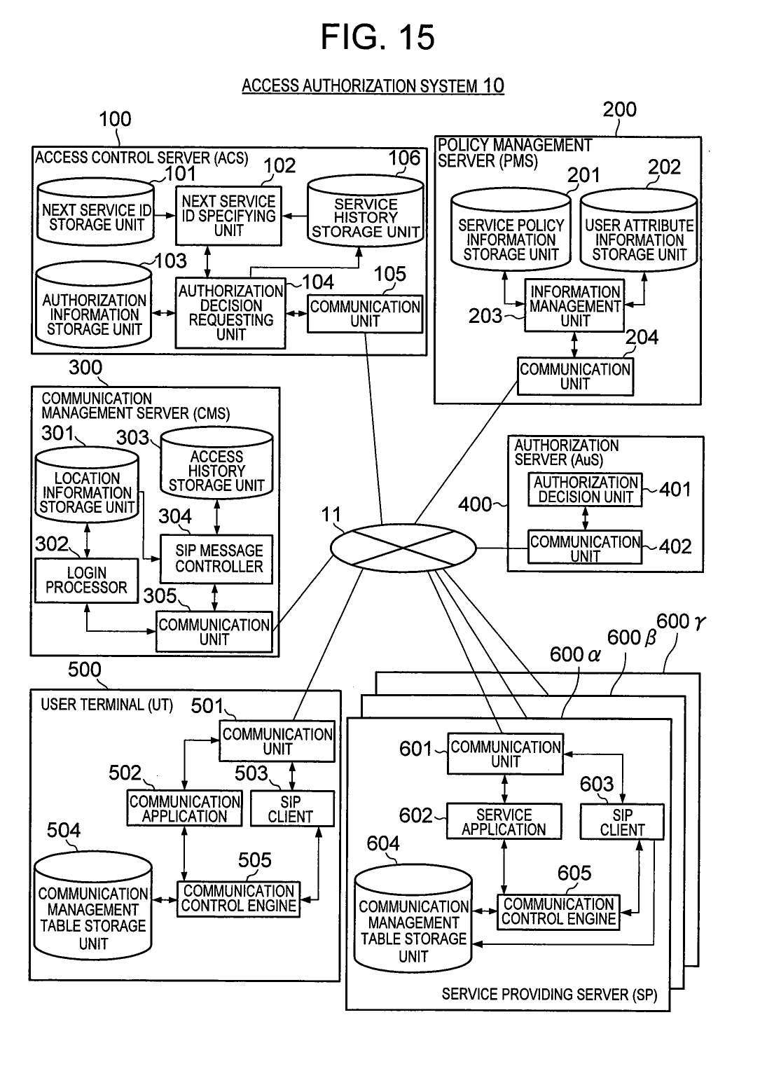

FIG. 15 is a system configuration diagram showing an exemplary configuration of an access authorization system 10 in accordance with the second embodiment. The access authorization system 10 is provided with an access control server (ACS) 100, a policy management server (PMS) 200, a communication management server (CMS) 300, an authorization server (AuS) 400, a user terminal (UT) 500, and a plurality of service providing servers (SP) 600. It should be appreciated that, except for the points to be described hereinafter, portions of the configuration in FIG. 15 having the same reference symbols as those in FIG. 1 are identical in configuration or function to the corresponding portions in FIG. 1, and for this reason description thereof is omitted herein for the sake of brevity.

Upon receiving from the ACS 100 an authorization information transmission notification containing a user ID, a service ID, and authorization information, the SIP client 603 of the SP 600 registers the received information in the communication management table storage unit 604, and then transmits a notification of authorization information transmission completion to the ACS 100.

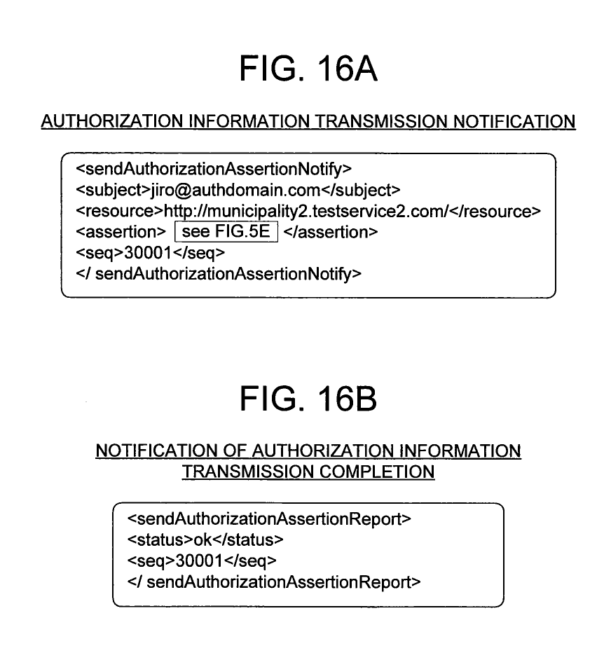

In the present embodiment, the authorization information transmission notification is created as an XML message using the “sendAuthorizationAssertionNotify” tag, as shown by way of example in FIG. 16A. FIG. 16A shows only the portions of the authorization information transmission notification necessary for describing the present embodiment. The user ID is specified in the “subject” tag. The service ID is specified in the “resource” tag. The authorization information (see FIG. 5E) is specified in the “assertion” tag. A request number for associating an authorization information transmission notification with a notification of authorization information transmission completion is specified in the “seq” tag.

In addition, in the present embodiment, the notification of authorization information transmission completion is created as an XML message using the “sendAuthorizationAssertionReport” tag, as shown by way of example in FIG. 16B. FIG. 16B shows only the portions of the completion of authorization information transmission notification necessary for describing the present embodiment. The result of receiving the authorization information transmission notification is specified in the “status” tag. A request number for associating an authorization information transmission notification with a notification of authorization information transmission completion is specified in the “seq” tag.

The ACS 100 is provided with a next service ID storage unit 101, a next service ID specifying unit 102, an authorization information storage unit 103, an authorization decision requesting unit 104, a communication unit 105, and a service history storage unit 106.

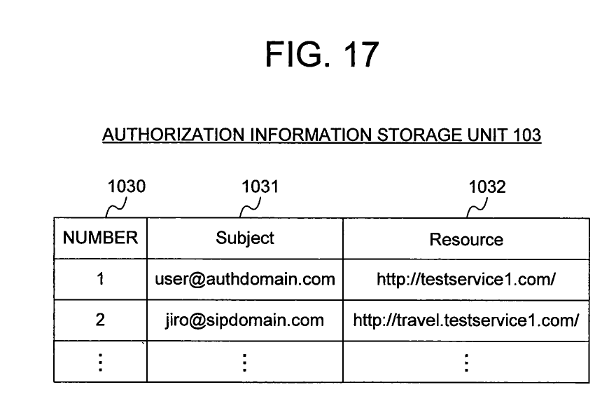

As shown by way of example in FIG. 17, the authorization information storage unit 103 stores a Subject 1031 specifying the SIP-URI of the user of the UT 500, as well as a Resource 1032 specifying the service ID. The above values are respectively associated with a number 1030 that identifies the record containing the values.

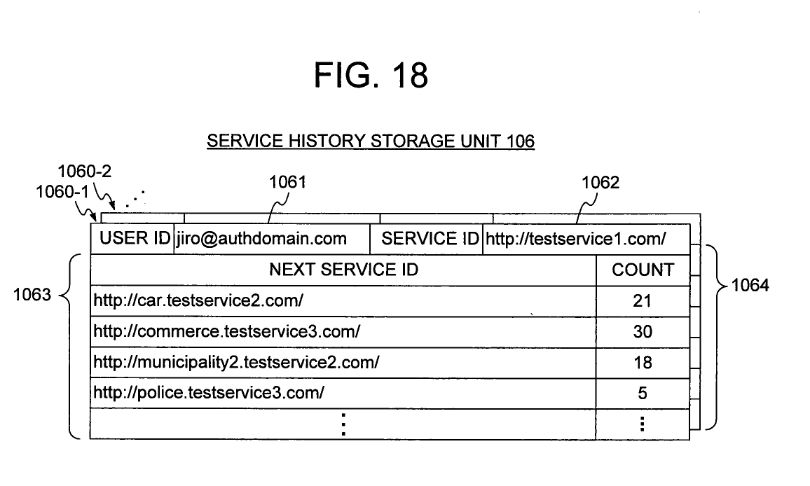

As shown by way of example in FIG. 18, the service history storage unit 106 stores a history table 1060 for each combination of a user ID 1061 and a service ID 1062. Each history table 1060 stores next service IDs 1063 specifying the service IDs of the services that have been provided to the user corresponding to the user ID 1061 after providing the service corresponding to the service ID 1062. The services corresponding to the next service IDs 1063 are stored in association with counts 1064 specifying the number of times a service has been provided.

Upon receiving a user ID and a service ID from the authorization decision requesting unit 104, the next service ID specifying unit 102 refers to the next service ID storage unit 101 and determines whether or not there exists a next service ID associated with the service ID. If there does exist a next service ID associated with the service ID, then the next service ID specifying unit 102 sends the next service ID to the authorization decision requesting unit 104, together with the user ID received from the authorization decision requesting unit 104.

On the other hand, if a next service ID associated with the service ID received from the authorization decision requesting unit 104 does not exist in the next service ID storage unit 101, then the next service ID specifying unit 102 refers to the service history storage unit 106 and specifies the history table 1060 corresponding to the user ID and the service ID received from the authorization decision requesting unit 104. Subsequently, the next service ID specifying unit 102 refers to the specified history table 1060, extracts the next service ID associated with a count equal to or greater than a predetermined threshold value (such as 20, for example), and then sends the extracted service ID to the authorization decision requesting unit 104, together with the user ID received from the authorization decision requesting unit 104. If the predetermined threshold value is taken to be a count of 20, then in the example shown in FIG. 18, the next service ID specifying unit 102 extracts two service IDs.

If a history table 1060 associated with the user ID and the service ID received from the authorization decision requesting unit 104 does not exist in the service history storage unit 106, or alternatively, if a next service ID associated with a count equal to or greater than a predetermined value does not exist in the history table 1060, then the next service ID specifying unit 102 replies to the authorization decision requesting unit 104 with the user ID received from the authorization decision requesting unit 104.

Upon receiving an authorization information query request (see FIG. 4C) from the CMS 300 via the communication unit 105, the authorization decision requesting unit 104 determines whether or not the combination of the user ID specified in the “subject” tag and the service ID specified in the “resource” tag of the authorization information query request exists in the authorization information storage unit 103. If the combination of the user ID and the service ID does exist in the authorization information storage unit 103, then the authorization decision requesting unit 104 creates an authorization information query response that does not include the “assertion” tag shown in FIG. 4D, and then transmits the created authorization information query response to the CMS 300 via the communication unit 105.

If the combination of the user ID and the service ID contained in the authorization information query request does not exist in the authorization information storage unit 103, then the authorization decision requesting unit 104 creates the registration information query request shown in FIG. 4E, and then transmits the created registration information query request to the PMS 200 via the communication unit 105. Subsequently, upon receiving the registration information query response shown in FIG. 4F from the PMS 200 via the communication unit 105, the authorization decision requesting unit 104 creates the authorization decision request shown in FIG. 5C, and then transmits the created authorization decision request to the AuS 400 via the communication unit 105.

In addition, upon receiving the authorization decision response shown in FIG. 5D from the AuS 400 via the communication unit 105, the authorization decision requesting unit 104 creates authorization information. Furthermore, if the authorization decision result contained in the authorization decision response indicates that provision of a service is permitted, then the authorization decision requesting unit 104 saves the user ID and the service ID contained in the created authorization information in the authorization information storage unit 103. Subsequently, the authorization decision requesting unit 104 creates an authorization information query response (see FIG. 4D), and then transmits the created authorization information query response to the CMS 300 via the communication unit 105.

After transmitting the authorization information query response to the CMS 300, the authorization decision requesting unit 104 sends, to the next service ID specifying unit 102, the user ID and the service ID contained in the authorization information query request that triggered the authorization information query response. Subsequently, upon receiving the user ID and a next service ID from the next service ID specifying unit 102, the authorization decision requesting unit 104 determines whether or not the combination of the user ID and the next service ID is registered in the authorization information storage unit 103.

If the combination of the user ID and the next service ID is not registered in the authorization information storage unit 103, then the authorization decision requesting unit 104 creates a registration information query request (see FIG. 4E) containing the user ID and the next service ID, and then sends the created registration information query request to the PMS 200. However, if the combination of the user ID and the next service ID is already registered in the authorization information storage unit 103, or alternatively, if the next service ID specifying unit 102 does not output a next service ID together with the user ID, then the authorization decision requesting unit 104 does not execute process to make an authorization decision in advance.

Subsequently, the authorization decision requesting unit 104 receives a registration information query response (FIG. 4F) from the PMS 200. The authorization decision requesting unit 104 then creates an authorization decision request (FIG. 5C) on the basis of the received registration information query response, and sends the created authorization decision request to the AuS 400. Subsequently, the authorization decision requesting unit 104 receives an authorization decision response (FIG. 5D) from the AuS 400, and then creates authorization information. Furthermore, if the authorization decision result contained in the authorization decision response indicates that provision of a service is permitted, then the authorization decision requesting unit 104 saves the user ID and the service ID contained in the created authorization information in the authorization information storage unit 103.

Subsequently, the authorization decision requesting unit 104 creates an authorization information transmission notification (see FIG. 16A) containing the created authorization information, and then transmits the created authorization information transmission notification to the SP 600 via the communication unit 105. Subsequently, the authorization decision requesting unit 104 receives the notification of authorization information transmission completion shown in FIG. 16B via the communication unit 105.

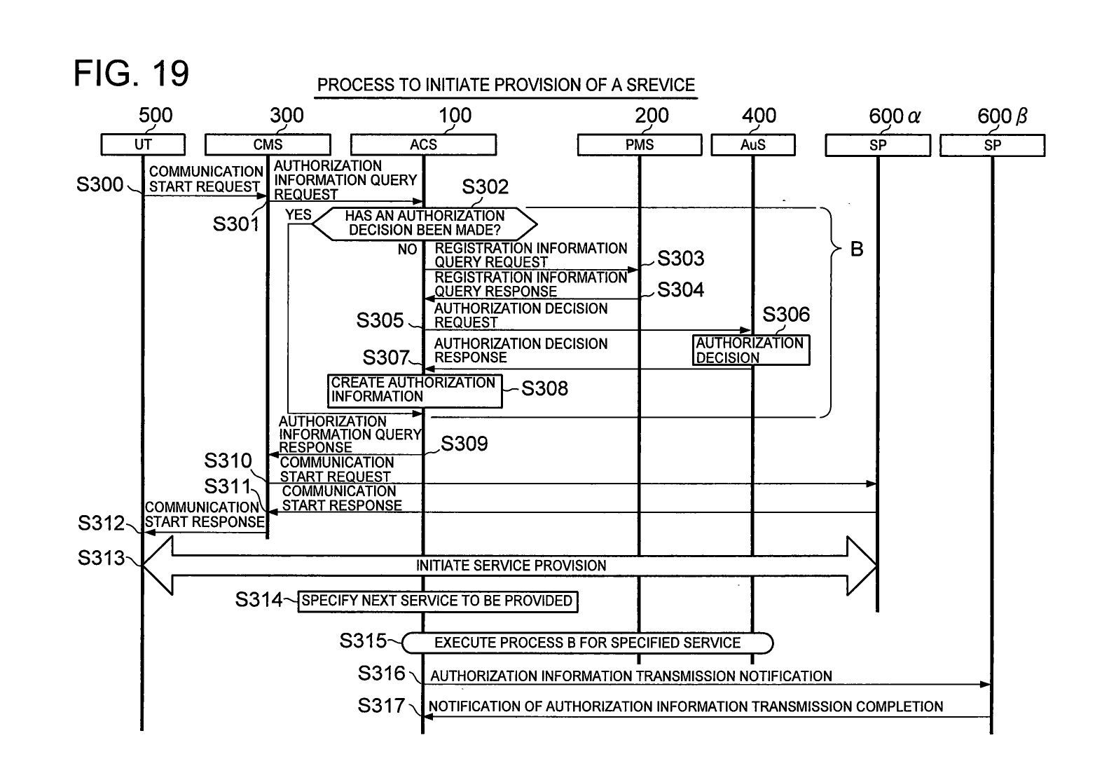

Next, the series of operations conducted by the access authorization system 10 in accordance with the second embodiment in the case where the provision of a service is commenced in response to a user request will be described with reference to FIG. 19.

First, the SIP client 503 of the UT 500 creates the communication start request shown in FIG. 4A in response to a request from the user, and then transmits the created communication start request to the CMS 300 (S300). The SIP message controller 304 of the CMS 300 then creates the authorization information query request shown in FIG. 4C on the basis of the communication start request received from the UT 500, and then transmits the created authorization information query request to the ACS 100 (S301).

The authorization decision requesting unit 104 of the ACS 100 determines whether or not the combination of the user ID and the service ID contained in authorization information query request received from the CMS 300 is stored in the authorization information storage unit 103 (S302). If the combination of the user ID and the service ID is stored in the authorization information storage unit 103 (S302: Yes), then the authorization decision requesting unit 104 executes the process shown in step S309.

If the combination of the user ID and the service ID contained in the authorization information query request received from the CMS 300 is not stored in the authorization information storage unit 103 (S302: No), then the authorization decision requesting unit 104 creates the registration information query request shown in FIG. 4E on the basis of the user ID and the service ID, and then transmits the created registration information query request to the PMS 200 (S303).

The information management unit 203 of the PMS 200 then acquires, on the basis of the user ID and the service ID contained in the registration information query request received from the ACS 100, the corresponding user attribute information and service policy information from the user attribute information storage unit 202 and the service policy information storage unit 201, respectively. Subsequently, the information management unit 203 creates a registration information query response (see FIG. 4F) containing the acquired user attribute information and service policy information, and then transmits the created registration information query response to the ACS 100 (S304).

Next, the authorization decision requesting unit 104 of the ACS 100 creates an authorization decision request (see FIG. 5C) containing the user attribute information and the service policy information contained in the registration information query response received from the PMS 200, and then transmits the created authorization decision request to the AuS 400 (S305). The authorization decision unit 401 of the AuS 400 then determines whether or not the user attribute information contained in the authorization decision request received from the ACS 100 satisfies the service policy information contained in the authorization decision request (S306). Subsequently, the authorization decision unit 401 creates an authorization decision response (see FIG. 5D) containing the authorization decision result, and then transmits the created authorization decision response to the ACS 100 (S307).

Next, the authorization decision requesting unit 104 of the ACS 100 creates the authorization information shown in FIG. 5E on the basis of the authorization decision response received from the AuS 400. Furthermore, if the authorization decision result contained in the authorization decision response indicates that use of the service is permitted, then the authorization decision requesting unit 104 saves the user ID and the service ID in the authorization information storage unit 103 (S308). Subsequently, the authorization decision requesting unit 104 creates the authorization information query response shown in FIG. 4D, and then transmits the created authorization information query response to the CMS 300 (S309).

Next, the SIP message controller 304 of the CMS 300 takes the destination of the communication start request shown in FIG. 4A to be the SIP-URI of the SP 600 that provides the service corresponding to the service ID, and creates a communication start request containing the authorization information contained in the authorization information query response received from the ACS 100. The SIP message controller 304 then transmits the created communication start request to the SP 600 (S310).

The SIP client 603 of the SP 600 creates the communication start response shown in FIG. 4B in response to the communication start request received from the CMS 300, and then transmits the created communication start response to the CMS 300 (S311). The SIP message controller 304 of the CMS 300 then rewrites a portion of the communication start response received from the SP 600, and then transmits the modified communication start response to the UT 500 (S312). Subsequently, the service application 602 of the SP 600 initiates provision of the service to the UT 500 (S313).

However, if it is determined in step S302 that the combination of the user ID and the service ID contained in the authorization information query request received from the CMS 300 is stored in the authorization information storage unit 103 (S302; Yes), then authorization information is contained neither in the authorization information query response transmitted in the subsequent step S309 nor in the communication start request transmitted in the subsequent step S310.

Next, the authorization decision requesting unit 104 of the ACS 100 sends, to the next service ID specifying unit 102, the user ID and the service ID contained in the authorization information in the authorization information query response that was transmitted in step S309. The next service ID specifying unit 102 refers to the next service ID storage unit 101 or the service history storage unit 106 and specifies the service ID of the next service to be provided by extracting the next service ID associated with the service ID received from the ACS 100 (S 314).

Next, the next service ID specifying unit 102 replies to the authorization decision requesting unit 104 with the specified next service ID, together with the user ID received from the authorization decision requesting unit 104. Subsequently, the authorization decision requesting unit 104 executes the process B shown from step S302 to step S308, using the user ID and the service ID received from the next service ID specifying unit 102 (S315).

Subsequently, the authorization decision requesting unit 104 transmits the authorization information transmission notification shown in FIG. 16A to the SP 600 (S316). The SIP client 603 of the SP 600 then stores the user ID, the service ID, and the authorization information contained in the received authorization information transmission notification in the communication management table storage unit 604, and then transmits the notification of authorization information transmission completion shown in FIG. 16B to the ACS 100 (S317).

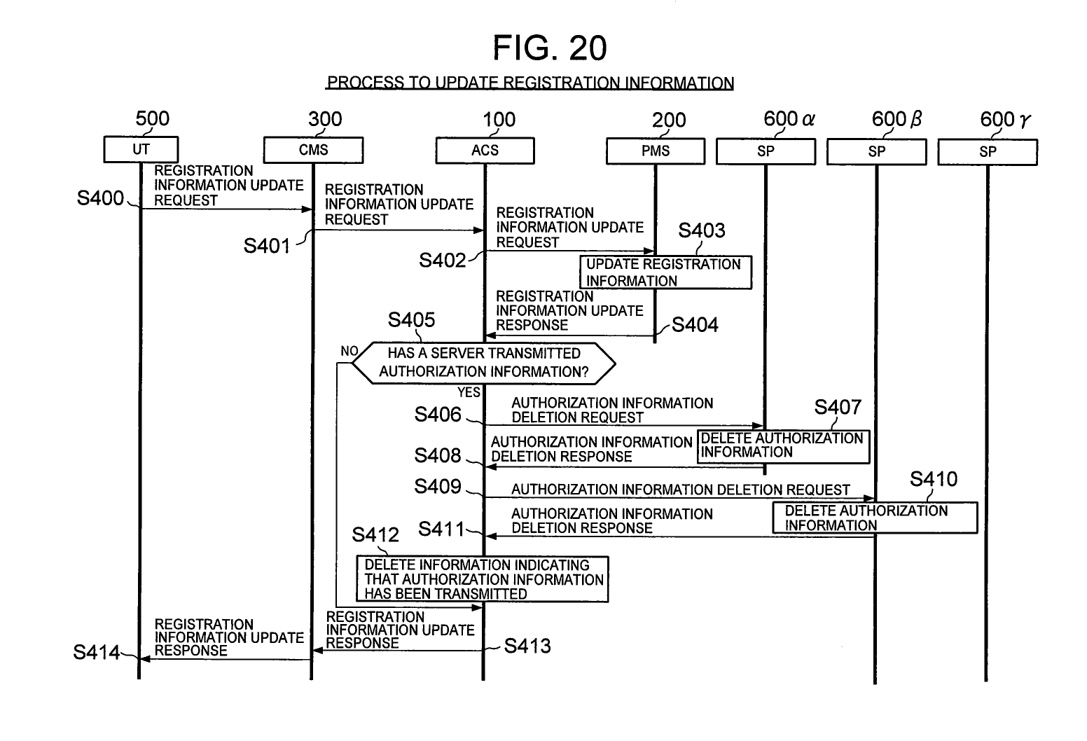

Next, the series of processes related to a user updating registration information via the UT 500 in accordance with the second embodiment will be described with reference to FIG. 20.

First, the SIP client 503 of the UT 500 creates the registration information update request shown in FIG. 6A in response to a request from a user, and then transmits the created registration information update request to the CMS 300 (S400). The SIP message controller 304 of the CMS 300 then creates the registration information update request shown in FIG. 6C on the basis of the registration information update request received from the UT 500, and then transmits the created registration information update request to the ACS 100 (S401).

The authorization decision requesting unit 104 of the ACS 100 forwards the registration information update request received from the CMS 300 to the PMS 200 (S402). The information management unit 203 of the PMS 200 then updates the user attribute information in the user attribute information storage unit 202 corresponding to the user ID contained in the registration information update request received from the ACS 100 with the user attribute information contained in the registration information update request. (S403). Subsequently, the information management unit 203 creates the registration information update response shown in FIG. 6D, and then transmits the created registration information update response to the ACS 100 (S404).

Next, the authorization decision requesting unit 104 of the ACS 100 determines whether or not the user ID contained in the registration information update request received in step S401 is stored in the authorization information storage unit 103 (S405). If the user ID is not stored in the authorization information storage unit 103 (S405: No), then the authorization decision requesting unit 104 executes the process shown in step S413.

If the user ID contained in the registration information update request received in step S401 is stored in the authorization information storage unit 103 (S405: Yes), then the authorization decision requesting unit 104 extracts the service IDs associated with the user ID from the authorization information storage unit 103, respectively creates the authorization information deletion request shown in FIG. 6E for each extracted service ID, and then transmits the created authorization information deletion requests (S406, S409). In the present example, it is supposed that authorization information indicating that provision of a service is permitted has already been passed to a SP 600-α and a SP 600-β, while authorization information indicating that provision of a service is permitted has not been passed to a SP 600-γ.

The respective SIP clients 603 of the SP 600-α and the SP 600-β refer to the communication management table storage unit 604 and delete, from the communication management table 6040, all records corresponding to the user ID contained in the authorization information deletion request received from the ACS 100 (S407, S410). Subsequently, each SIP client 603 creates the authorization information deletion response shown in FIG. 6F, and then transmits the created authorization information deletion response to the ACS 100 (S408, S411).

Next, the authorization decision requesting unit 104 of the ACS 100 deletes, from the authorization information storage unit 103, all records containing the user ID contained in the registration information update request received in S401 (S412), and then forwards the registration information update response received in step S404 to the CMS 300 (S413). The SIP message controller 304 of the CMS 300 then creates the registration information update response shown in FIG. 6B on the basis of the registration information update response received from the ACS 100, and then transmits the created registration information update response to the UT 500 (S414).

Hereinabove, the second embodiment of the present invention has been described. Like the first embodiment, in the access authorization system 10 of the present embodiment, the user wait time until provision of a user-request service commences is reduced.

Furthermore, in the present embodiment, the ACS 100 immediately transmits the result of a previously-conducted authorization decision to the SP 600 that will use the authorization decision result. In so doing, transmitting an authorization information query response from the ACS 100 to the CMS 300 becomes unnecessary, and stating the authorization information in the communication start request transmitted from the CMS 300 to the SP 600 also becomes unnecessary. For this reason, the data size of the authorization information query response and the communication start request, which are sent and received after the provision of a service is request by a user, is reduced. Consequently, the access authorization system 10 is able to reduce the time involved in data communication once the provision of a service is requested by a user, and thus the user wait time until provision of the service commences is reduced.

### Embodiment 3

Next, a third embodiment of the present invention will be described. A business process execution system 40 in accordance with the present embodiment realizes a single service by linking a plurality of Web services that realize an SAML-based access control according to a service scenario.

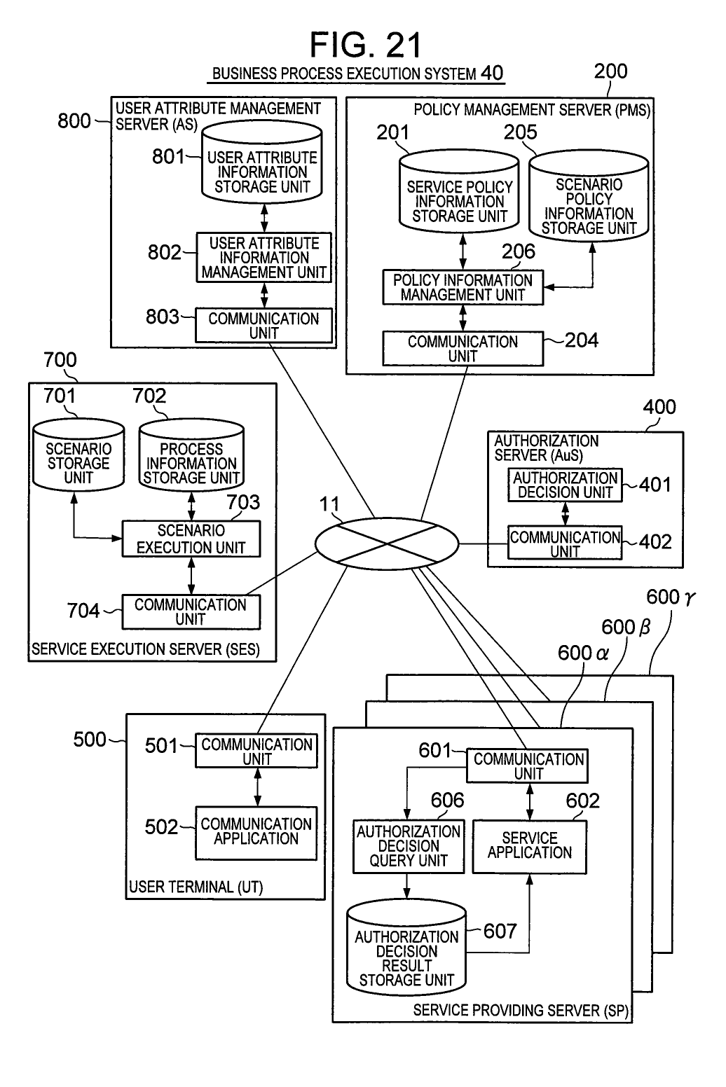

FIG. 21 is a system configuration diagram illustrating an exemplary configuration of the business process execution system 40 in accordance with the third embodiment. The business process execution system 40 is provided with a policy management server (PMS) 200, an authorization server (AuS) 400, a user terminal (UT) 500, a plurality of service-providing servers (SP) 600, a service execution server (SES) 700, and a user attribute management server (AS) 800.

The business process execution system 40 shown in FIG. 21 operates in the following manner. When a user is to use, via the UT 500, a service scenario being provided by the SES 700, the SES 700 cooperates with the AuS 400 to make authorization decisions that determine whether or not provision of the respective Web services included in the service scenario to the user is permitted. On the basis of the authorization decision results, the SES 700 then sequentially calls the respective Web services in the order stipulated by the service scenario.

Next, the function of each configuration element in the business process execution system 40 in accordance with the present embodiment will be described. It should be appreciated that, except for the points to be described hereinafter, portions of the configuration in FIG. 21 having the same reference symbols as those in FIG. 1 are identical in configuration or similar in function to the corresponding portions in FIG. 1, and for this reason description thereof is omitted herein for the sake of brevity.

First, the service execution server 700 will be described. The SES 700 is provided with a scenario storage unit 701, a process information storage unit 702, a scenario execution unit 703, and a communication unit 704. The communication unit 704 communicates with other devices via the network 11 according to instructions from the scenario execution unit 703.

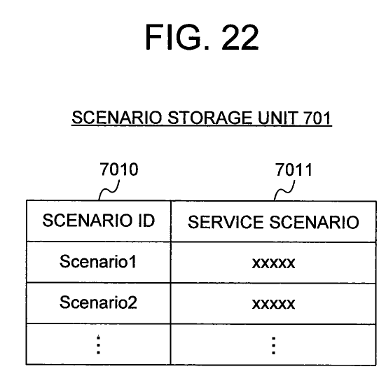

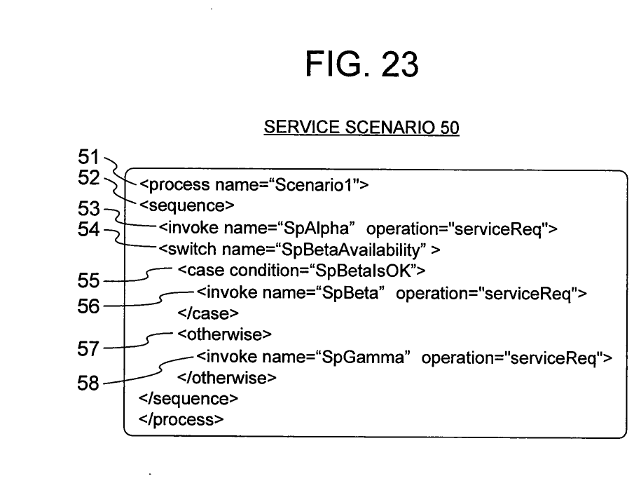

As shown by way of example in FIG. 22, the scenario storage unit 701 stores service scenarios 7011 in association with scenario IDs 7010 identifying respective service scenarios. Herein, a service scenario is a statement in XML format, that stipulates the order whereby Web services being provided by one or more SPs 600 are to be linked, as shown by way of example in FIG. 23.

FIG. 23 shows, by way of example, a service scenario 50 having a scenario ID “Scenariol”. In the service scenario 50 shown in FIG. 23, a link sequence is stipulated wherein a Web service having an identifying service ID “SpAlpha” is executed (see statement 53), and subsequently, if a Web service having the service ID “SpBeta” is executable (see statement 55), then the Web service having the service ID “SpBeta” is executed (see statement 56), else the Web service having the service ID “SpGamma” is executed (see statement 58).

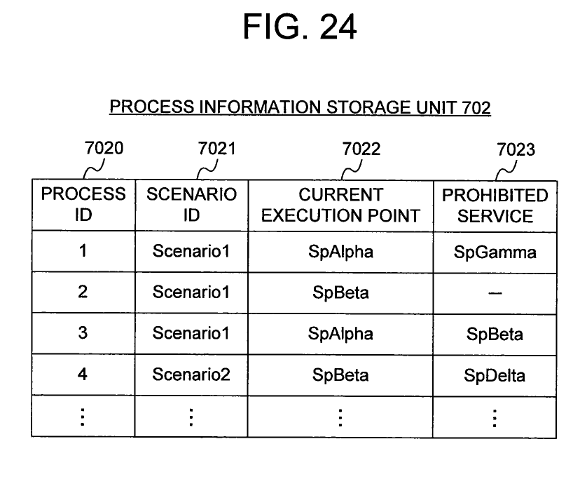

As shown by way of example in FIG. 24, the process information storage unit 702 stores records containing a scenario ID 7021 for a service scenario currently being executed, a current execution point 7022 indicating the service ID of the Web service currently being executed, and a prohibited service 7023 indicating the service ID of a Web service whose execution is prohibited. The above values are respectively stored in association with a process ID 7020 that identifies the respective business process. The process information storage unit 702 shown in FIG. 24 stores information with respect to a business process having the process ID “1”, wherein a service scenario having the scenario ID “Scenariol” is currently being executed, and within that scenario a Web service having the service ID “SpAlpha” is currently being executed, while a Web service having the service ID “SpGamma” is prohibited from execution.

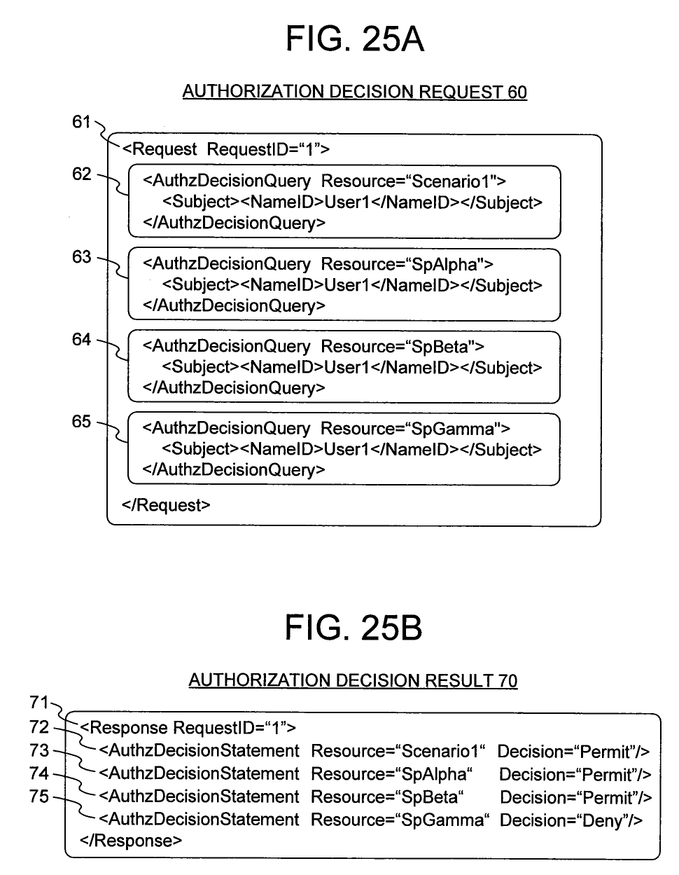

Upon receiving a service request containing a user ID and a scenario ID from the UT 500 via the communication unit 704, the scenario execution unit 703 generates a process ID, and then registers the received scenario ID in association with the generated process ID in the process information storage unit 702. (At this point, the current execution point and Prohibited Service fields are blank.) Subsequently, the scenario execution unit 703 extracts from the scenario storage unit 701 the service scenario corresponding to the scenario ID, and then extracts the service IDs of the respective Web services whose execution order is stipulated in the service scenario. Subsequently, the scenario execution unit 703 generates an authorization decision request 60 like that shown by way of example in FIG. 25A, and then transmits the generated authorization decision request 60 to the AuS 400 via the communication unit 704.

As shown by way of example in FIG. 25A, the authorization decision request 60 contains an identifier identifying each authorization decision request 60 (see statement 61), information related to the service scenario that is the subject of the authorization decision (see statement 62), and information related to the one or more Web services contained in the service scenario (see statements 63 to 65). The process ID, for example, may be used as the identifier that identifies the authorization decision request 60.

In FIG. 25A, the statement 62 specifies the scenario ID “Scenariol” of the service scenario to be authorized, as well as the user ID “User1” of the user who is the subject of the authorization decision with respect to the service scenario. The statement 63 specifies the service ID “SpAlpha” of a Web service to be authorized, as well as the user ID “User1” of the user who is the subject of the authorization decision with respect to the Web service.

The statement 64 specifies the service ID “SpBeta” of a Web service to be authorized, as well as the user ID “User1” of the user who is the subject of the authorization decision with respect to the Web service. The statement 65 specifies the service ID “SpGamma” of a Web service to be authorized, as well as the user ID “User1” of the user who is the subject of the authorization decision with respect to the Web service.

As a response to the authorization decision request 60, the scenario execution unit 703 receives an authorization decision result 70 like that shown by way of example in FIG. 25B from the AuS 400 via the communication unit 704. The authorization decision result 70 contains an identifier that identifies each authorization decision result 70 (see statement 71), an authorization decision result regarding the service scenario that was the subject of the authorization decision (see statement 72), as well as authorization decision results regarding the one or more Web services contained in the service scenario (see statements 73 to 75). The identifier that identifies the authorization decision result 70 specifies the identification information of the corresponding authorization decision request 60.

In the example shown in FIG. 25B, the statement 72 specifies the scenario ID “Scenariol” of the service scenario that was the subject of the authorization decision, as well as information indicating that the authorization decision result with respect to the service scenario is permitted “Permit”. The statement 73 specifies the service ID “SpAlpha” of a Web service that was the subject of the authorization decision, as well as information indicating that the authorization decision result with respect to the Web service is permitted “Permit”. The statement 74 specifies the service ID “SpBeta” of a Web service that was the subject of the authorization decision, as well as information indicating that the authorization decision result with respect to the Web service is permitted “Permit”. The statement 75 specifies the service ID “SpGamma” of a Web service that was the subject of the authorization decision, as well as information indicating that the authorization decision result with respect to the Web service is denied “Deny”.

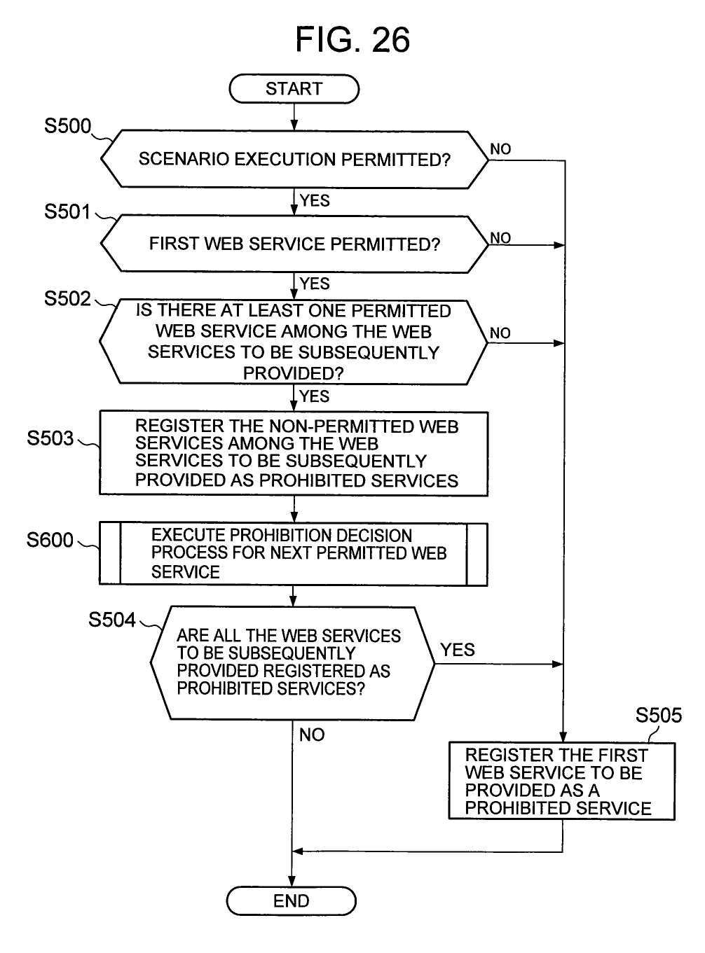

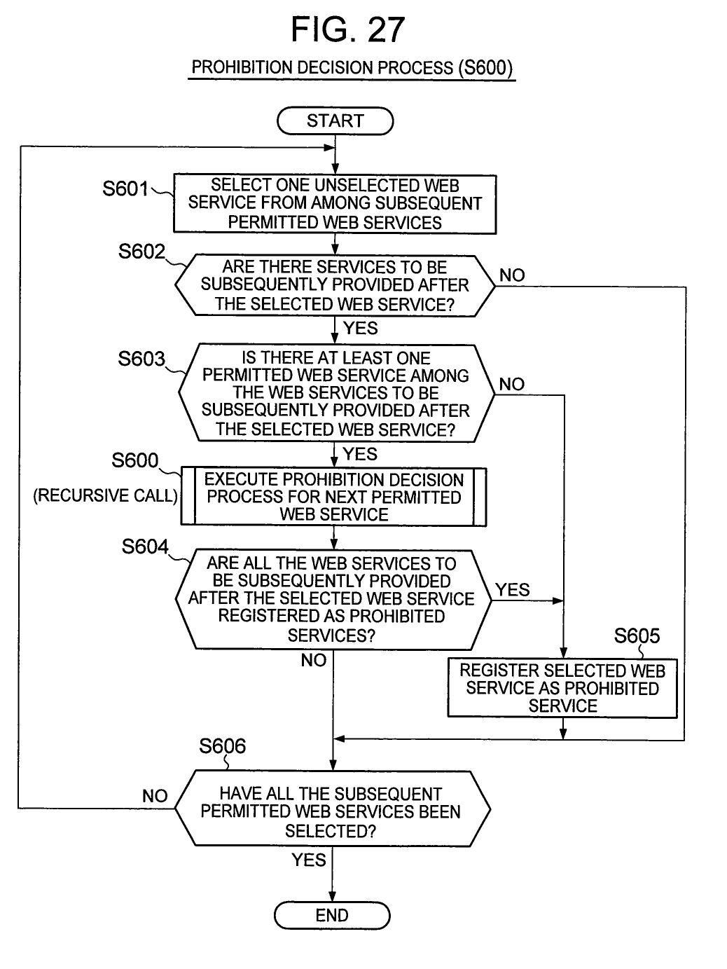

Upon receiving the authorization decision result 70 from the AuS 400, the scenario execution unit 703 executes prohibited service registration process as shown by way of example in FIGS. 26 and 27 on the basis of the received authorization decision result 70. In so doing, the scenario execution unit 703 determines, for each service contained in the service scenario requested by the user, whether or not each service is to be registered as a prohibited service. For services determined to be registered as prohibited services, the scenario execution unit 703 registers the respective service IDs thereof in association with the process ID in the process information storage unit 702.

In FIG. 26, the scenario execution unit 703 first determines whether or not the service scenario specified by the user is permitted (S500). The service scenario specified by the user is not permitted (S500: No), then the scenario execution unit 703 registers the first Web service stipulated by the service scenario as a prohibited service in association with the process ID in the process information storage unit 702 (S505). The scenario execution unit 703 then terminates the process shown in the flowchart in FIG. 26.

If the service scenario specified by the user is permitted (S500: Yes), then the scenario execution unit 703 subsequently determines whether or not the first Web service stipulated by the service scenario is permitted (S501). If the first Web service is not permitted (in other words, if the authorization decision result is “Deny”) (S501: No), then the scenario execution unit 703 executes the process shown in step S505.

If the first Web service is permitted (S501: Yes), then the scenario execution unit 703 specifies the Web services to be subsequently provided on the basis of the service scenario specified by the user, and then determines whether or not there exists at least one permitted Web service among the Web services to be subsequently provided (S502). If none of the Web services to be subsequently provided are permitted (S502: No), then the scenario execution unit 703 executes the process shown in step S505.

If at least one Web service to be subsequently provided is permitted (S502: Yes), then the scenario execution unit 703 registers as prohibited services the service IDs of any non-permitted services among the Web services to be subsequently provided in association with the process ID in the process information storage unit 702 (S503). Subsequently, the scenario execution unit 703 executes prohibition decision process, to be hereinafter described, with respect to the permitted Web services to be subsequently provided (S600).

Next, the scenario execution unit 703 determines whether or not all of the Web services to be subsequently provided are registered as prohibited services in the process information storage unit 702 (S504). If all of the Web services to be subsequently provided are registered as prohibited services in the process information storage unit 702 (S504: Yes), then the scenario execution unit 703 executes the process shown in step S505. On the other hand, if at least one Web service to be subsequently provided is not registered as a prohibited service in the process information storage unit 702 (S504: No), then the scenario execution unit 703 terminates the process shown in the flowchart in FIG. 26.

FIG. 27 is a flowchart showing an example of the prohibition decision process (S600) executed by the scenario execution unit 703.

First, the scenario execution unit 703 selects a single unselected Web service from among the permitted Web services to be subsequently provided (S601). Referring to the service scenario specified by the user, the scenario execution unit 703 then determines whether or not there exist subsequent Web services to be provided next to the selected Web service (S602). If subsequent Web services to be provided next to the selected Web service do not exist (S602: No), then the scenario execution unit 703 executes the process shown in step S606.

If subsequent Web services to be provided next to the selected Web service do exist (S602: Yes), then the scenario execution unit 703, on the basis of the service scenario specified by the user, specifies the Web services to be provided subsequent to the Web service that was selected in step S601, and then determines whether or not there exists at least one permitted Web service among the Web services to be subsequently provided (S603).

If none of the Web services to be subsequently provided are permitted (S603: No), then the scenario execution unit 703 registers the service ID of the Web service that was selected in step S601 as a prohibited service in association with the process ID in the process information storage unit 702. The scenario execution unit 703 then executes the process shown in step S606.

If there exists at least one permitted Web service among the Web services to be subsequently provided (S603: Yes), then the scenario execution unit 703 executes prohibition decision process with respect to the next permitted Web service by means of a recursive call (S 600). Subsequently, the scenario execution unit 703 determines whether or not all of the Web services to be subsequently provided next to the Web service that was selected in step S601 are registered as prohibited services in the process information storage unit 702 (S604).

If all of the Web services to be subsequently provided next to the Web service that was selected in step S601 are registered as prohibited services in the process information storage unit 702 (S604: Yes), then the scenario execution unit 703 executes the process shown in step S605. On the other hand, if at least one Web service to be subsequently provided next to the Web service that was selected in step S601 is not registered as a prohibited service in the process information storage unit 702 (S604: No), then the scenario execution unit 703 determines whether or not all of the permitted Web services were selected in step S601 (S606).

If not all of the permitted Web services were selected in step S601 (S606: No), then the scenario execution unit 703 again executes the process shown in step S601. On the other hand, if all of the permitted Web services were selected in step S601 (S606: Yes), then the scenario execution unit 703 terminates the prohibition decision process shown in the flowchart in FIG. 27.

After executing the process shown in FIGS. 26 and 27, the scenario execution unit 703 refers to the process information storage unit 702. If the first Web service stipulated in the service scenario requested by the user is not registered as a prohibited service in the process information storage unit 702, then the scenario execution unit 703 transmits a service call to the SP 600 that provides the first Web service. The service call contains the service ID of the Web service, as well as the user ID of the user to be provided with the Web service. By transmitting the service call, the scenario execution unit 703 starts provision of the series of business processes to the user. Subsequently, the scenario execution unit 703 registers the service ID of the first Web service in the current execution point of the process information storage unit 702. However, if the first Web service is registered as a prohibited service in the process information storage unit 702, then the scenario execution unit 703 issues a notification to the UT 500 containing information indicating that the specified service scenario cannot be executed.

In addition, the scenario execution unit 703, during a process of the SPs 600 executing sequential Web service in accordance with the service scenario specified by the user, manages information indicating the status of the series of business processes. Furthermore, if there exists a plurality of selections of Web services to be provided next to the Web service currently being provided in accordance with the service scenario, then the scenario execution unit 703 specifies the next Web service to be provided according to information indicating the status of the series of the business processes, and then causes the SP 600 to execute the specified Web service.

If the next Web service to be provided that was specified according to the information indicating the status of the series of business processes is registered as a prohibited service in the process information storage unit 702, then the scenario execution unit 703 issues a notification to the UT 500 containing information indicating that provision of the Web service is not permitted, along with information regarding the Web service. In so doing, the scenario execution unit 703 is able to prevent users of the UT 500 from needlessly receiving subsequently provided Web services.

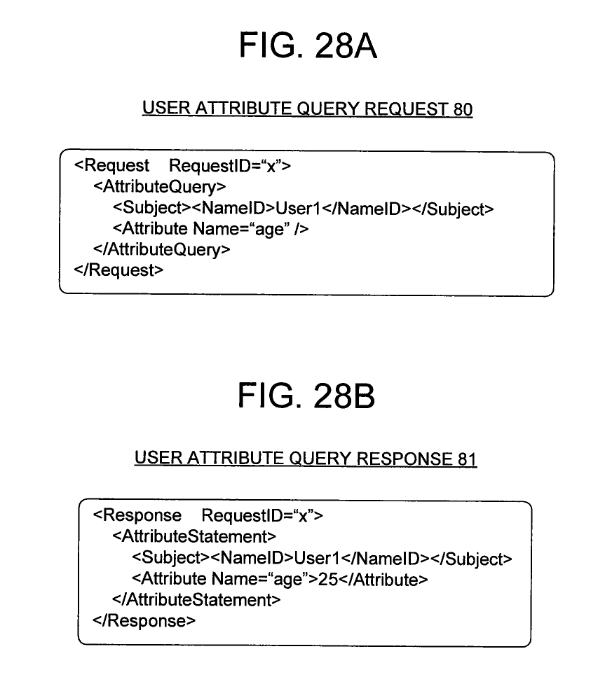

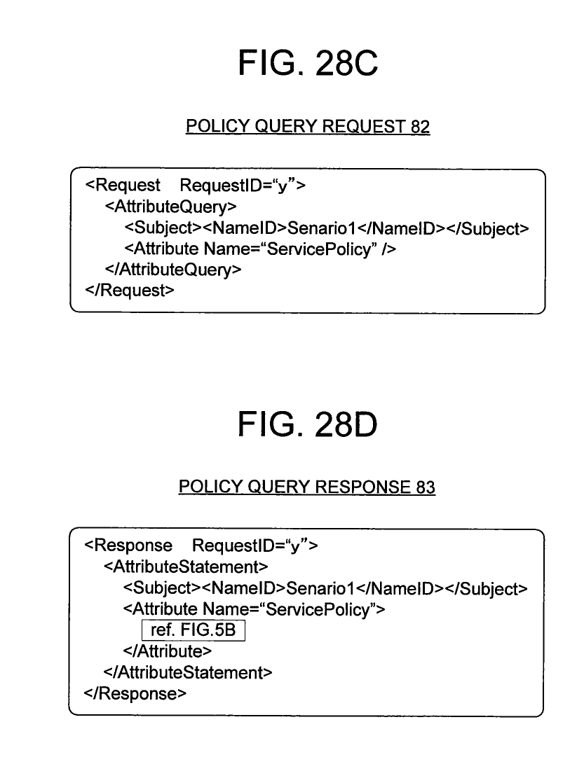

Next, the AuS 400 will be described. The AuS 400 is provided with an authorization decision unit 401 and a communication unit 402. Upon receiving the authorization decision request 60 shown in FIG. 25A from the SES 700 via the communication unit 402, the authorization decision unit 401 creates a policy query request 82 like that shown by way of example in FIG. 28C with respect to the scenario ID and respective service IDs contained in the authorization decision request 60. The authorization decision unit 401 then transmits the created policy query request 82 to the PMS 200 via the communication unit 402. FIG. 28C shows a policy query request 82 requesting the policy regarding a service scenario.

Upon receiving a policy query response 83 like that shown by way of example in FIG. 28D from the PMS 200 via the communication unit 402, the authorization decision unit 401 creates a user attribute query request containing the user parameters indicated in the policy query response 83 (in the examples shown in FIG. 28D, the user's age), as well as the user ID contained in the authorization decision request 60 received from the SES 700. The authorization decision unit 401 then transmits the created user attribute query request to the AS 800 via the communication unit 402. In the present embodiment, the user attribute query request has a data structure like that shown by way of example in FIG. 28A.

Subsequently, upon receiving a user attribute query response 81 like that shown by way of example in FIG. 28B from the AS 800 via the communication unit 402, the authorization decision unit 401 makes authorization decisions to determine whether or not the user attributes contained in the user attribute query response 81 satisfy the service policy contained in the policy query response 83 with respect to the service scenario corresponding to the scenario ID specified in the authorization decision request 60 as well as the respective Web services corresponding to the service IDs specified in the authorization decision request 60.

Subsequently, the authorization decision unit 401 creates the authorization decision result 70 described with reference to FIG. 25B, and then transmits the created authorization decision result 70 to the SES 700 via the communication unit 402. In addition, for each service ID wherein the authorization decision result is “Permit”, the authorization decision unit 401 issues a notification containing the authorization decision result along with the user ID of the relevant user to the SP 600 that provides the Web service corresponding to the service ID.

In the present embodiment, the user attribute information for a single user is requested using a single user attribute query request 80. However, as another example, the user attribute information for a plurality of users may be requested using a single user attribute query request 80. More specifically, an “AttributeQuery” tag may be created for each user within the user attribute query request 80. Furthermore, in the present embodiment, the service policy information for a single Web service is requested using a single policy query request 82. However, as another example, the service policy information for a plurality of Web services may be requested using a single policy query request 82. More specifically, an “AttributeQuery” tag may be created for each Web service within the policy query request 82. In so doing, communication traffic between the AuS 400 and the PMS 200 can be reduced.

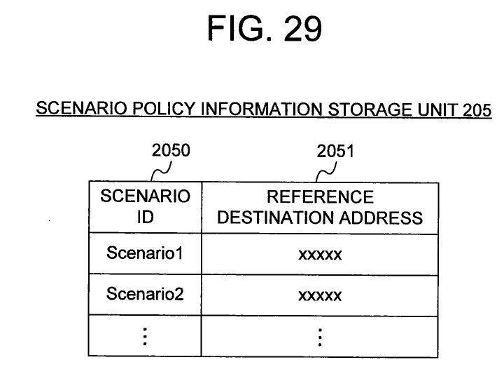

Next, the PMS 200 will be described. The PMS 200 is provided with a service policy information storage unit 201, a communication unit 204, a scenario policy information storage unit 205, and a policy information management unit 206. The service policy information storage unit 201 stores data having a structure like that described with reference to FIG. 10. As shown by way of example in FIG. 29, the scenario policy information storage unit 205 stores, in association with a scenario ID 2050, a reference destination address 2051 indicating the location of the PMS 200 in the memory where the actual scenario policy information for the service scenario corresponding to the scenario ID 2050 is stored.

Upon receiving the policy query request 82 shown in FIG. 28C from the AuS 400 via the communication unit 204, the policy information management unit 206 conducts the following. If the policy query request 82 stores a service ID, then the policy information management unit 206 refers to the service policy information storage unit 201 and acquires service policy information corresponding to the received service ID. If the policy query request 82 stores a scenario ID, then the policy information management unit 206 refers to the scenario policy information storage unit 205 and acquires scenario policy information corresponding to the received scenario ID. Subsequently, the policy information management unit 206 creates a policy query response 83 containing the acquired service policy information or the acquired scenario policy information, and then transmits the created policy query response 83 to the AuS 400 via the communication unit 204.

Next, the AS 800 will be described. The AS 800 is provided with a user attribute information storage unit 801, a user attribute information management unit 802, and a communication unit 803. The communication unit 803 communicates with other devices via the network 11 according to instructions from the user attribute information management unit 802. The user attribute information storage unit 801 stores data having a structure like that described with reference to FIG. 11, for example.

Upon receiving the user attribute query request 80 shown in FIG. 28A from the AuS 400 via the communication unit 803, the user attribute information management unit 802 extracts from the user attribute information storage unit 801 the user attribute information corresponding to the user ID stored in the user attribute query request 80. Subsequently, the user attribute information management unit 802 creates a user attribute query response 81 containing the extracted user attribute information, and then transmits the created user attribute query response 81 to the AuS 400 via the communication unit 803.

Next, the SP 600 will be described. The SP 600 is provided with a communication unit 601, a service application 602, an authorization decision query unit 606, and an authorization decision result storage unit 607.

Upon receiving the user ID of a user whose authorization decision result is “Permit” from the AuS 400 via the communication unit 601, the authorization decision query unit 606 stores the received user ID in the authorization decision result storage unit 607. If there exists a plurality of Web services providable by the SP 600, then the AuS 400 transmits to the SP 600 the service ID of the relevant Web service together with the user ID and the authorization decision result of “Permit”, and the authorization decision query unit 606 subsequently stores the user ID of the user whose authorization decision result is “Permit”, together with the service ID of the relevant service, in the authorization decision result storage unit 607.

Upon receiving a service call from the SES 700 via the communication unit 601, the service application 602 determines whether or not the user ID contained in the received service call is stored in the authorization decision result storage unit 607. If the user ID is stored in the authorization decision result storage unit 607, then the service application 602 determines that provision of the Web service to the user corresponding to the user ID is permitted, and subsequently provides the Web service to the user corresponding to the user ID.

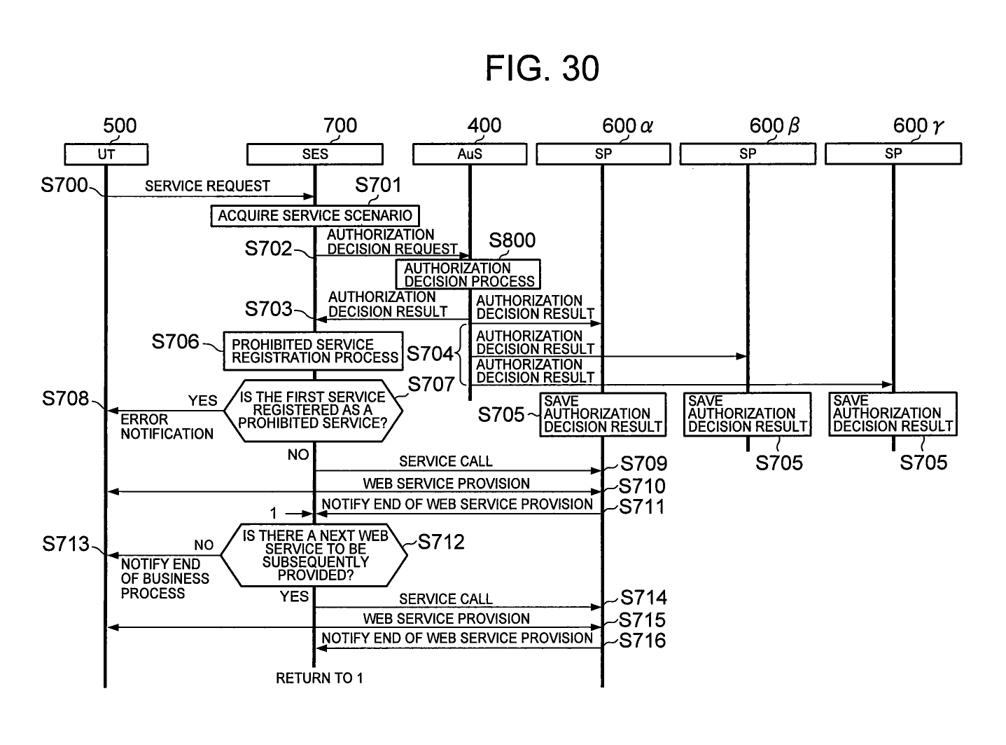

Next, the series of operations conducted by the business process execution system 40 in accordance with the third embodiment in the case where provision of a Web service is initiated according to a user request will be described with reference to FIG. 30.

First, the communication application 502 of the UT 500 creates a service request according to a request from the user, and then transmits the created service request to the SES 700 via the communication unit 501 (S700). Upon receiving the service request via the communication unit 704, the scenario execution unit 703 of the SES 700 generates a process ID, and then registers the scenario ID contained in the service request in association with the generated process ID in the process information storage unit 702. Subsequently, the scenario execution unit 703 acquires the service scenario corresponding to the scenario ID from the scenario storage unit 701 (S701), and then extracts the service IDs of the respective Web services whose execution order is stipulated in the service scenario. Subsequently, the scenario execution unit 703 generates a authorization decision request 60 like that shown by way of example in FIG. 25A, and then transmits the generated authorization decision request 60 to the AuS 400 via the communication unit 704 (S702).

Upon receiving the authorization decision request 60 shown in FIG. 25A from the SES 700 via the communication unit 402, the authorization decision unit 401 of the AuS 400 executes authorization decision process, to be hereinafter described (S800). Subsequently, the authorization decision unit 401 creates an authorization decision result 70 like that described with reference to FIG. 25B, and then transmits the created authorization decision result 70 to the SES 700 via the communication unit 402 (S703). Subsequently, for each service ID wherein the authorization decision result is “Permit”, the authorization decision unit 401 issues a notification containing the authorization decision result along with the user ID of the relevant user to the SP 600 that provides the Web service corresponding to a respective service ID (S704). The authorization decision query unit 606 of each SP 600 respectively receives, from the AuS 400 via the communication unit 601, the user ID of the user whose authorization decision result is “Permit”, and then stores the user ID of the user in the authorization decision result storage unit 607 (S705).

Next, the scenario execution unit 703 of the SES 700 executes the prohibited service registration process described with reference to FIGS. 26 and 27 on the basis of the authorization decision result received from the AuS 400 (S706). Subsequently, the scenario execution unit 703 refers to the process information storage unit 702 and determines whether or not the first Web service stipulated in the service scenario requested by the user is registered as a prohibited service in the process information storage unit 702 (S707).

If the first Web service is registered as a prohibited service in the process information storage unit 702 (S707: Yes), then the scenario execution unit 703 transmits an error notification to the UT 500 indicating that the specified service scenario cannot be executed (S708). On the other hand, if the first Web service is not registered as a prohibited service in the process information storage unit 702 (S707: No), then the scenario execution unit 703 transmits, to the SP 600α that provides the first Web service, a service call containing the service ID of the Web service as well as the user ID of the user to be provided with the Web service (S709). Subsequently, the scenario execution unit 703 registers the service ID of the first Web service in the current execution point in the process information storage unit 702.

Next, if the user ID contained in the received service call is stored in the authorization decision result storage unit 607, then the service application 602 of the SP 600α determines that provision of the Web service to the user corresponding to the user ID is permitted, and subsequently provides the Web service to the UT 500 of the user corresponding to the user ID (S710).

Subsequently, when the provision of the Web service has ended, the service application 602 issues a notification to the SES 700 containing information indicating the execution result of the provided Web service, together with information indicating that provision of the Web service has ended (S711). The scenario execution unit 703 of the SES 700 then updates the information indicating the status of the series of business processes on the basis of the information indicating the execution result of the Web service. Subsequently, the scenario execution unit 703 refers to the service scenario specified by the user, and determines whether or not there exists a next Web service to be subsequently provided (S712). If a next Web service to be subsequently provided does not exist (S712: No), then the scenario execution unit 703 issues a notification to the UT 500 containing information indicating that the business process has ended (S713).

If a next Web services to be subsequently provided does exist (S712: Yes), then the scenario execution unit 703 transmits, to the SP 600α that provides the next Web service to be subsequently provided, a service call containing the service ID of the Web service, as well as the user ID of the user to be provided with the Web service (S714). Subsequently, the scenario execution unit 703 registers the service ID of the next Web service to be subsequently provided in the current execution point in the process information storage unit 702.

If the user ID contained in the received service call is stored in the authorization decision result storage unit 607, then the service application 602 of the SP 600α provides the Web service to the UT 500 of the user corresponding to the user ID (S716). Subsequently, when the provision of the Web services has ended, the service application 602 issues a notification to the SES 700 containing information indicating the execution result of the provided Web service, together with information indicating that provision of the Web service has ended (S711). The scenario execution unit 703 of the SES 700 then executes the process shown in step S712 again, thereby updating the information indicating the status of the series of business processes on the basis of the information indicating the execution result of the Web service.

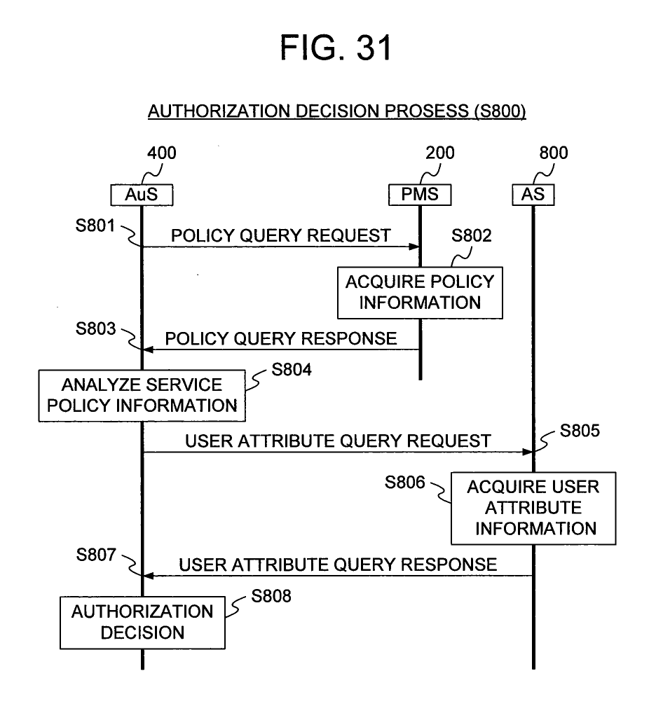

FIG. 31 is a sequence diagram showing an example of authorization decision process (S800).

First, upon receiving the authorization decision request 60 shown in FIG. 25A from the SES 700 via the communication unit 402, the authorization decision unit 401 of the AuS 400 generates a policy query request 82 like that shown by way of example in FIG. 28C with respect to the scenario ID and respective service IDs contained in the authorization decision request 60. The authorization decision unit 401 then transmits the created policy query request 82 to the PMS 200 via the communication unit 402 (S801).

If a service ID is contained in the policy query request 82 received from the AuS 400 via the communication unit 204, then the policy information management unit 206 of the PMS 200 refers to the service policy information storage unit 201 and acquires corresponding service policy information. If a scenario ID is contained in the policy query request 82, then the policy information management unit 206 refers to the scenario policy information storage unit 205 and acquires corresponding scenario policy information (S802). Subsequently, the policy information management unit 206 creates a policy query response 83 containing the acquired service policy information or the acquired scenario policy information, and then transmits the created policy query response 83 to the AuS 400 via the communication unit 204 (S803).

The authorization decision unit 401 of the AuS 400 analyzes the policy query response 83 received from the PMS 200 via the communication unit 402, and then creates a user attribute query request 80 containing the user parameters indicated in the policy query response 83 as well as the user ID that was contained in the authorization decision request 60 received from the SES 700. The authorization decision unit 401 then transmits the created user attribute query request 80 to the AS 800 via the communication unit 402 (S805).

The user attribute information management unit 802 of the AS 800 acquires from the user attribute information storage unit 801 the user attribute information corresponding to the user ID stored in the user attribute query request 80 that was received from the AuS 400 via the communication unit 803. Subsequently, the user attribute information management unit 802 creates a user attribute query response 81 containing the acquired user attribute information, and then transmits the created user attribute query response 81 to the AuS 400 via the communication unit 803 (S807).

Subsequently, the authorization decision unit 401 of the AuS 400 executes process for making an authorization decision to determine whether or not the user attributes contained in the user attribute query response 81 received from the AS 800 satisfy the service policy contained in the policy query response 83 (S808) with respect to the service scenario corresponding to the scenario ID specified in the authorization decision request 60, as well as the respective Web services corresponding to the service IDs specified in the authorization decision request 60.

Hereinabove, the third embodiment of the present invention has been described. According to the business process execution system 40 in accordance with the present embodiment, the authorization decision for a Web service provided by a SP 600 is conducted between the receiving of a service request from the UT 500 by the SES 700 and the issuing of a service call to the SP 600 by the SES 700. In addition, after the authorization decision has been made, the AuS 400 transmits the results thereof to the SP 600, and the SP 600 then saves those results. In so doing, it is not necessary to execute authorization decision process after the SP 600 has been called, and thus user wait time can be reduced.

In addition, in the business process execution system 40 in accordance with the present embodiment, the SES 700 specifies the Web services stipulated in the service scenario requested by the UT 500, and then requests an authorization decision from the AuS 400. In addition, the AuS 400 transmits the authorization decision result to the SP 600, and the SP 600 then saves the authorization decision result. In other words, the authorization decision result saved by the SP 600 is related to the service scenario that the SES 700 is attempting to execute. For this reason, it is highly likely that a Web service call will be issued to the SP 600 in a comparatively short amount of time, and unnecessary saving of authorization decision results is reduced.

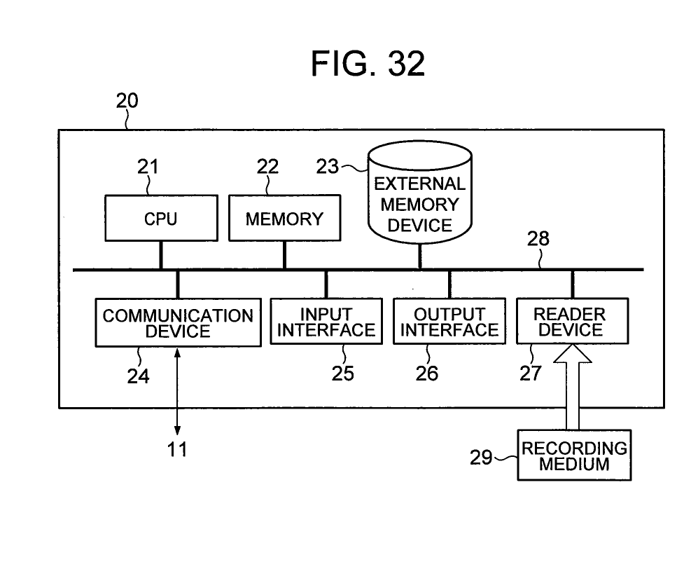

It should be appreciated that any of the ACS 100, the PMS 200, the CMS 300, the AuS 400, the UT 500, the SP 600, the SES 700, and the AS 800 in the foregoing embodiments may be realized by a computer 20 configured like that shown in FIG. 32, for example.

The computer 20 is provided with a CPU 21, memory 22, a communication device 24 for conducting communication with other computers 20 via a network 11 such as the Internet or a LAN, an input interface 25 that connects input devices such as a keyboard and mouse, an output interface 26 that connects output device such as a monitor and printer, a reader device 27, and an external memory device 23 such as a hard disk. All of the above configuration elements are mutually connected via a bus 28. In addition, a portable recording medium 29 such as an IC card or USB memory can be connected to the reader device 27.

The computer 20 functions as any one device out of the ACS 100, the PMS 200, the CMS 300, the AuS 400, the UT 500, and the SP 600. The computer 20 loads a program for realizing the functions of the any one device into the memory 22, and by executing the program using the CPU 21, the functions of the corresponding device are realized. These programs may be stored in advance in the external memory device 23, or they may be acquired as necessary from another device by the reader device 27 or the communication device 24 via a medium usable by the computer 20, and then stored in the external memory device 23.

The medium refers to, for example a recording medium 29 that can be loaded into and ejected from the reader device 27, or alternatively, the network 11 connected to the communication device 24 or a carrier wave or digital signal that propagates the network 11. Furthermore, after being temporarily stored in the external memory device 23, these programs may be loaded into the memory 22 and executed by the CPU 21, or alternatively, the programs may be loaded directly into the memory 22 and executed by the CPU 21 without first being stored in the external memory device 23.

In addition, in both the first and the second embodiment described above, the next service ID specifying unit 102 specified the service ID of the single next service to be provided after the service currently being provided. However, as another example, the next service ID specifying unit 102 may also be configured to specify the service IDs for all services to be executed after the current service in a work flow containing the service currently being provided, and then provide these specified service IDs to the authorization decision requesting unit 104.

In addition, in the second embodiment, the next service ID specifying unit 102 inferred the next service to be provided using a count of the number of times a particular service has been provided after the service currently being provided. However, besides the above, the service with a high possibility of being next request may also be inferred using well-known data mining techniques based on data such as the user's past service usage history and attribute information.

In addition, in the third embodiment, the authorization decisions with respect to the service scenario provided by the SES 700 as well as the Web services provided by the SP 600 were made by the AuS 400 in an integrated manner, but it should be appreciated that the present invention is not limited to such a configuration. For example, respective SPs 600 may also be configured to make authorization decisions regarding the Web services provided by that SP 600. In other words, the functions of the AuS 400 may also be built into the SP 600. Furthermore, the functions of the PMS 200 or the AS 800 may also be built into respective SPs 600.

If the SP 600 is configured to execute process for making authorization decisions with respect to the Web services provided by that SP 600, then the number of messages exchanged in order to make an authorization decision is reduced, and thus the network space is effectively utilized. In such a configuration, the authorization decision process is still executed prior to the issuing of a Web service call to a SP 600 from the SES 700, and the respective SP 600 still saves the authorization result. For this reason, it is not necessary to actually execute the authorization decision process, even if a Web service is called. As a result, the provision of Web services can be promptly started.

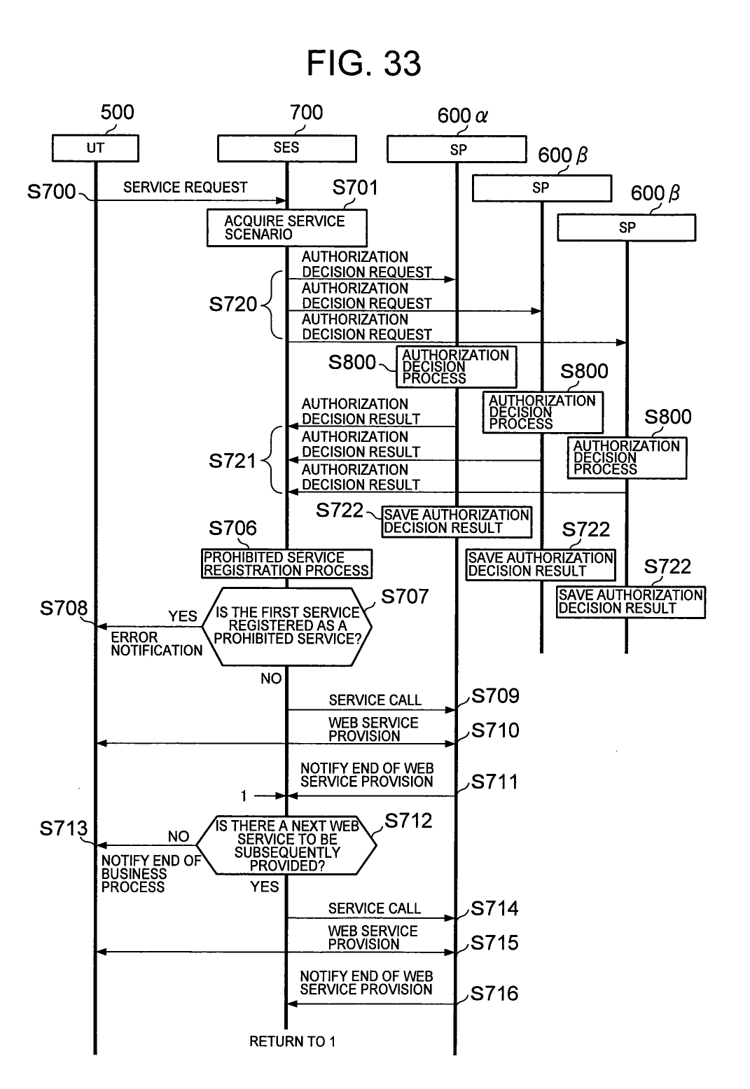

The operation of the business process execution system 40 in the case where the functions of the AuS 400 are built into the SP 600 becomes like that shown in FIG. 33, for example. It should be appreciated that, except for the points to be described hereinafter, processes in FIG. 33 having the same reference symbols as those in FIG. 30 are similar to the corresponding processes in FIG. 30, and for this reason further description thereof is omitted herein for the sake of brevity.

The scenario execution unit 703 of the SES 700 first extracts service IDs from a service scenario acquired from the scenario storage unit 701, and then generates an authorization decision request 60 like that shown by way of example in FIG. 25A. Subsequently, the scenario execution unit 703 transmits the generated authorization decision request 60 to the respective SPs 600 that provides the Web services corresponding to the extracted service IDs (S720). It should be appreciated that by transmitting a authorization decision request 60 containing a scenario ID to any one of the SPs 600, the scenario execution unit 703 causes SP 600 to execute process for making an authorization decision with respect to the service scenario specified by the user.

After executing the authorization decision process (S800) described with reference to FIG. 31, the respective SPs 600 respectively create the authorization decision result 70 described with reference to FIG. 25B, and then transmit the created authorization decision result 70 to the SES 700 (S721). Subsequently, if the authorization decision result is “Permit”, then the respective SPs 600 store the authorization decision result in the authorization decision result storage unit 607, together with the user ID of the target user (S722).

In addition, in the third embodiment described above, if the scenario execution unit 703 receives a service request from the UT 500, then the scenario execution unit 703 batch executes the process for making authorization decisions with respect to the Web services whose execution order is stipulated in the service scenario corresponding to the scenario ID contained in the service request. However, the present invention is not limited to the above. For example, the scenario execution unit 703 may cause the AuS 400 to only make authorization decisions with respect to the service scenario specified by the user and the first Web service stipulated in the service scenario. If both the service scenario and the first Web service are permitted, then provision of the first Web service is started.

Subsequently, while the first Web service is being provided, the scenario execution unit 703 may refer to the service scenario specified by the user, and then cause the AuS 400 to make authorization decision with respect to the respective Web services stipulated in the service scenario. In so doing, the time for user to wait for the provision of the first Web service is reduced. Furthermore, after the SP 600 starts provision of the first Web service, the scenario execution unit 703 executes the prohibited service registration process shown in FIGS. 26 and 27. If the first Web service is registered as a prohibited service in the process information storage unit 702, then the scenario execution unit 703 preferably transmits an error notification to the UT 500 containing information indicating that the UT 500 is unable to receive any subsequently provided Web services immediately. Alternatively, if a Web service contained in the service scenario is registered as a prohibited service, it is preferable for the scenario execution unit 703 to immediately transmit an error notification to the UT 500 containing information indicating that the UT 500 is unable to receive any subsequently provided Web services, even if the provision of the prohibited Web service has already been started.

In addition, in the third embodiment described above, the scenario execution unit 703 determines the next Web service to be subsequently provided on the basis of a combination of the Web service corresponding to the service ID registered in the process information storage unit 702 as the current execution point, and the service scenario corresponding to the scenario ID registered in the process information storage unit 702. However, the present invention is not limited to the above. For example, the scenario execution unit 703 may create a new service scenario by editing the service scenario specified by the user, such that the Web service registered as a prohibited service in the process information storage unit 702 is not included therein, and then execute the newly created service scenario. As a result, a conditional branching wherein a call is issued for a Web service whose execution is denied could be eliminated, and thus the next Web service to be executed can be called more rapidly.

The present invention was described in the foregoing using exemplary embodiments, but the technical scope of the present invention is not limited to that described in the foregoing exemplary embodiments. It should be clear to those skilled in the art that various modifications and alterations may be made to the foregoing embodiments. It should furthermore be clear from the scope of the appended claims that embodiments wherein such various modifications and alterations have been made are to be included within the technical scope of the present invention.

The specification and drawings are, accordingly, to be regarded in an illustrative rather than a restrictive sense. It will, however, be evident that various modifications and changes may be made thereto without departing from the spirit and scope of the invention as set forth in the claims.

We claim:

1. An access authorization system that, on the basis of a service request from a client-side communication device, makes an authorization decision for determining whether or not the provision of the requested service is permitted for the user using the communication device, the system comprising:
a policy management server;
an authorization server; and
an access control server;
wherein
the policy management server includes
user attribute information storage unit for storing user attribute information for each user ID identifying a user of the client-side communication device,
service policy information storage unit for storing service policy information for each service ID identifying a service, with the service policy information indicating a user's conditions whereby a user is permitted to receive a provided service, and
information management unit that, upon receiving a registration information query request containing a user ID and a service ID from the access control server, extracts user attribute information corresponding to the user ID from the user attribute information storage unit, extracts service policy information corresponding to the service ID from the service policy information storage unit, and then transmits to the access control server a registration information query response containing the extracted user attribute information and service policy information,
the authorization server includes
authorization decision unit that, upon receiving from the access control server an authorization decision request containing user attribute information and service policy information, determines whether or not the user attribute information satisfies the service policy information, and then transmits the authorization decision response containing an authorization decision result, the user ID subject to the authorization decision result, and the service ID subject to the authorization decision result to the access control server,
the access control server includes
next service ID storage unit for storing, for each service ID, the service ID for the next service to be provided,
authorization decision requesting unit that, upon receiving an authorization information query request requesting authorization information indicating whether or not the user of the client-side communication device is permitted to use a service and containing the user ID of the user and the service ID of the service, transmits to the policy management server a registration information query request containing the user ID and the service ID, and upon receiving from the policy management server a registration information query response containing the user attribute information corresponding to the user ID and the service policy information corresponding to the service ID, transmits to the authorization server an authorization decision request containing the user attribute information and the service policy information, and upon receiving from the authorization server an authorization decision response, outputs an authorization information query response containing the authorization decision result, the user ID, and the service ID that were contained in the authorization decision response, and
next service specifying unit that, after the authorization decision requesting unit outputs the authorization information query response, refers to the next service ID storage unit on the basis of the service ID of the service subject to the authorization decision result contained in the authorization information query response, extracts the service ID of the next service to be provided, and then transmits the extracted service ID, along with the user ID of the user subject to the authorization decision result, to the authorization decision requesting unit,
and wherein
during the period between outputting the authorization information query response and receiving another authorization information query request containing a user ID identical to the user ID contained in the authorization information query response, the authorization decision requesting unit acquires from the policy management server the user attribute information and the service policy information corresponding to the user ID and the service ID received from the next service specifying unit, and then transmits to the authorization server an authorization decision request containing the user attribute information and the service policy information, thereby causing the authorization server to execute authorization decision process in advance with respect to the combination of the user corresponding to the user ID and the service corresponding to the service ID.

2. The access authorization system according to claim 1, wherein
the access control server further includes
service history storage unit for storing, for respective combinations of a user ID and a service ID, the service ID of the next service that was requested by the user corresponding to the user ID, and,
if the service ID of the next service to be provided after the service subject to the authorization decision result contained in the authorization information query response is not stored in the next service ID storage unit, then the next service specifying unit refers to the service history storage unit, infers the service ID of the next service to be provided after the service subject to the authorization decision result, and then sends the inferred service ID, as well as the user ID of the user subject to the authorization decision result, to the authorization decision requesting unit.

3. The access authorization system according to claim 2, wherein
the service history storage unit further stores, for respective combinations of a user ID and a service ID, cumulative values for the number of times that each service has been requested after the service corresponding to the service ID by the user corresponding to the user ID, and,
if the service ID of the next service to be provided after the service subject to the authorization decision result contained in the authorization information query response is not stored in the next service ID storage unit, then the next service specifying unit refers to the service history storage unit and, among the service IDs associated with the combination of the user ID of the user and the service ID of the service respectively subject to the authorization decision result contained in the authorization information query response, the next service specifying unit infers the service ID associated with a request count that is equal to or greater than a predetermined value as the service ID of the next service to be provided after the service subject to the authorization decision result.

4. The access authorization system according to claim 1, wherein,
during the period between outputting the authorization information query response and receiving another authorization information query request containing a user ID identical to the user ID contained in the authorization information query response, the authorization decision requesting unit acquires from the policy management server the user attribute information and the service policy information corresponding to the user ID and the service ID received from the next service specifying unit, and then transmits to the authorization server an authorization decision request containing the user attribute information and the service policy information, receives an authorization decision response from the authorization server as a result, stores the authorization decision result contained in the received authorization decision response, and subsequently, upon receiving an authorization information query request containing the user ID and the service ID subject to the stored authorization decision result, outputs an authorization information query response containing the authorization decision result, the user ID of the user subject to the authorization decision result, and the service ID of the service subject to the authorization decision result.

5. The access authorization system according to claim 1, wherein,
during the period between outputting the authorization information query response and receiving another authorization information query request containing a user ID identical to the user ID contained in the authorization information query response, the authorization decision requesting unit acquires from the policy management server the user attribute information and the service policy information corresponding to the user ID and the service ID received from the next service specifying unit, and then transmits to the authorization server an authorization decision request containing the user attribute information and the service policy information, receives an authorization decision response from the authorization server as a result, and then transmits, to the service-providing server that provides the service, an authorization information transmission notification containing the authorization decision result, the user ID of the user subject to the authorization decision result, and the service ID of the service subject to the authorization decision result that were contained in the received authorization decision response.

6. The access authorization system according to claim 1, wherein,
during the period between outputting the authorization information query response and receiving another authorization information query request containing a user ID identical to the user ID contained in the authorization information query response, if the process load on the access control server is less than a predetermined threshold value, then the authorization decision requesting unit acquires from the policy management server the user attribute information and the service policy information corresponding to the user ID and the service ID received from the next service specifying unit, and then transmits to the authorization server an authorization decision request containing the user attribute information and the service policy information.

7. An access control server, used in an access authorization system
that, on the basis of a service request from a client-side communication device, makes an authorization decision regarding the service provided for the user using the communication device, the system being provided with,
a policy management server that includes
user attribute information storage unit for storing user attribute information for each user ID identifying a user of the client-side communication device,
service policy information storage unit for storing service policy information indicating a user's conditions to be permitted to receive a provided service for each service ID identifying a service, and
information management unit that, upon receiving a registration information query request containing a user ID and a service ID, extracts user attribute information corresponding to the user ID from the user attribute information storage unit, extracts service policy information corresponding to the service ID from the service policy information storage unit, and then replies with a registration information query response containing the extracted user attribute information and service policy information, and
an authorization server that includes
authorization decision unit that, upon receiving an authorization decision request containing user attribute information and service policy information, makes an authorization decision to determine whether or not the user attribute information satisfies the service policy information, and then replies with an authorization decision response containing the authorization decision result, the user ID of a user subject to the authorization decision result, and the service ID of a service subject to the authorization decision result,
the access control server comprising:
next service ID storage unit for storing, for each service ID, the service ID for the next service to be provided;
authorization decision requesting unit that, upon receiving an authorization information query request requesting authorization information indicating whether or not the user of the client-side communication device is permitted to use a service and containing the user ID of the user and the service ID of the service, transmits to the policy management server a registration information query request containing the user ID and the service ID, and upon receiving from the policy management server a registration information query response containing the user attribute information corresponding to the user ID and the service policy information corresponding to the service ID, transmits to the authorization server an authorization decision request containing the user attribute information and the service policy information, and upon receiving from the authorization server an authorization decision response, outputs an authorization information query response containing the authorization decision result, the user ID, and the service ID that were contained in the authorization decision response; and
next service specifying unit that, after the authorization decision requesting unit outputs the authorization information query response, refers to the next service ID storage unit on the basis of the service ID of the service subject to the authorization decision result contained in the authorization information query response, extracts the service ID of the next service to be provided, and then transmits the extracted service ID, along with the user ID of the user subject to the authorization decision result, to the authorization decision requesting unit;
wherein
during the period between outputting the authorization information query response and receiving another authorization information query request containing a user ID identical to the user ID contained in the authorization information query response, the authorization decision requesting unit acquires from the policy management server the user attribute information and the service policy information corresponding to the user ID and the service ID received from the next service specifying unit, and then transmits to the authorization server an authorization decision request containing the user attribute information and the service policy information, thereby causing the authorization server to execute authorization decision process in advance with respect to the combination of the user corresponding to the user ID and the service corresponding to the service ID.

8. A business process execution system that makes an authorization decision for determining, with respect to a business process made up of a plurality of services requested by a client-side communication device, whether or not the provision of individual services included in the business process is permitted for the user of the communication device, the system comprising:
a user attribute management server;
a policy management server;
an authorization server; and
a service execution server;
wherein
the user attribute management server includes
user attribute information storage unit for storing user attribute information for each user ID identifying a user of the client-side communication device, and
user attribute information management unit that, upon receiving a user attribute query request containing a user ID from the authorization server, extracts user attribute information corresponding to the user ID from the user attribute information storage unit, and then transmits to the authorization server a user attribute query response containing the extracted user attribute information,
the policy management server includes
service policy information storage unit for storing service policy information indicating a user's conditions to be permitted to receive a provided service for each service ID identifying a service, and
policy information management unit that, upon receiving a policy query request containing a service ID from the authorization server, extracts service policy information corresponding to the service ID from the service policy information storage unit, and then transmits to the authorization server a policy query response containing the extracted service policy information,
the authorization server includes
authorization decision unit that, upon receiving from the service execution server an authorization decision request containing a user ID and one or more service ID, transmits to the user attribute management server a user attribute query request containing the user ID, acquires user attribute information corresponding to the user ID, transmits to the policy management server a policy query request containing the service ID acquires service policy information corresponding to the service ID, subsequently determines whether or not the acquired user attribute information satisfies the acquired service policy information, and then transmits to the service execution server an authorization decision response containing an authorization decision result for each service ID, and
the service execution server includes
scenario storage unit for storing service scenarios that stipulate the provision order for a plurality of services included in a business process, the service scenarios being respectively stored in association with a scenario ID that identifies a particular service scenario, and
scenario execution unit that, upon receiving a service request containing a user ID and a scenario ID from a client-side communication device, acquires the service scenario corresponding to the scenario ID from the scenario storage unit, and then transmits to the authorization server an authorization decision request containing the user ID as well as the service IDs of the respective services contained in the acquired service scenario, thereby acquiring an authorization decision result for respective services contained in the service scenario, and subsequently, if the entire series of services included in the service scenario are permitted, then the scenario execution unit issues a request of provision of the service to the user of the user ID to the service-providing server that executes the first service to be provided in the service scenario

9. The business process execution system according to claim 8, wherein
there exist branches in the service scenario whereby the services to be provided subsequent to a given service differ according to conditions,
the service execution server further includes
process information storage unit for storing, for each process ID identifying respective processes, the scenario ID of the service scenario currently being executed, the service ID of the service currently being executed, and the service IDs of services whose provision is prohibited,
the scenario execution unit,
upon acquiring from the authorization server the authorization decision results for the respective services in the service scenario specified by the user, generates a process ID, and then registers the scenario ID of the service scenario as the scenario ID of the service scenario currently being executed in the process information storage unit and in association with the generated process ID,
executes prohibited service registration process with respect to the respective services in the service scenario such that, in the case where there exist services to be provided subsequent to a particular service, if either the particular service is not permitted or all of the services to be subsequently provided are prohibited, then the scenario execution unit registers the service ID of the particular service as the service ID of the service whose provision is prohibited in the process information storage unit and in association with the generated process ID, whereas in the case where there do not exist services to be provided subsequent to the particular service, if the particular service is not permitted, then the scenario execution unit registers the service ID of the particular service as the service ID of a service whose provision is prohibited in the process information storage unit and in association with the generated process ID, and
referring to the process information storage unit for the results of the prohibited service registration process executed with respect to the respective services stored therein, if the first service to be provided is not prohibited, then the scenario execution unit determines that the entire series of services included in the service scenario specified by the user is permitted, issues a request to the service-providing server that provides the first service requesting the execution of the first service to be provided, and registers the service ID of the service as the scenario ID of the service scenario currently being executed in the process information storage unit and in association with the generated process ID.

10. The business process execution system according to claim 8, wherein
the policy management server further includes
scenario policy information storage unit for storing, for each scenario ID, scenario policy information indicating a user's conditions whereby the provision of the service scenario corresponding to a scenario ID is permitted,
the policy information management unit
upon receiving from the authorization server a policy query request containing a scenario ID, extracts from the scenario policy information storage unit the scenario policy information corresponding to the scenario ID, and then transmits a policy query response containing the extracted scenario policy information to the authorization server,
the authorization server
upon receiving from the service execution server an authorization decision request that further includes a scenario ID, transmits to the policy management server a policy query request containing the scenario ID, further acquires scenario policy information corresponding to the scenario ID, determines whether or not the user attribute information acquired from the user attribute management server satisfies the scenario policy information, and then transmits to the service execution server an authorization decision response further containing an authorization decision result associated with the scenario ID, and,
the scenario execution unit
upon receiving the service request from the client-side communication device, transmits to the authorization server an authorization decision request further containing the scenario ID contained in the service request, further acquires an authorization decision result with respect to the service scenario corresponding to the scenario ID as a result, and in the case where the execution of the service scenario is permitted, subsequently determines whether or not the entire series of services included in the service scenario are permitted.

11. The business process execution system according to claim 8, wherein
the authorization decision unit
transmits to the service-providing servers the authorization decision results made in response to an authorization decision request received from the service execution server prior to receiving authorization decision request regarding the user from the service-providing servers that provide the respective services subject to the authorization decisions.

12. The business process execution system according to claim 8, wherein
respective service-providing servers include the functions of the authorization server,
the scenario execution unit
upon receiving a service request containing a user ID and a scenario ID from a client-side communication device, acquires the service scenario corresponding to the service ID from the scenario storage unit, transmits an authorization decision request containing the user ID and the service IDs of the services included in the acquired service scenario to the service-providing servers that execute the respective services, and receives authorization decision results with respect to the services included in the service scenario as a result, and,
respective service-providing servers,
on the basis of the authorization decision request received from the service execution server, makes an authorization decision to determine whether or not provision of a service to the user corresponding to the user ID contained in the authorization decision request is permitted, transmits to the service execution server an authorization decision response containing the authorization decision result and the service ID of the service subject to the authorization decision result, and stores the authorization decision result in association with the user ID.
